(19) United States
(12) Patent Application Publication
(10) Pub. No.: US 2026/0368716 A1
(43) Pub. Date: Nov. 19, 2026

(54) ELECTRONIC VALIDATION OBJECT CREATION AND MANAGEMENT FOR FRAUD RESISTANCE OF PHYSICAL INSTRUMENTS

(71) Applicant: U.S. Bank National Association, Minneapolis, MN (US)

(72) Inventor: William Andrew Zieska, Champlin, MN (US)

(73) Assignee: U.S. Bank National Association, Minneapolis, MN (US)

(21) Appl. No.: 19/209,460

(22) Filed: May 15, 2025

(51) Int. Cl. G06Q 20/32; G06Q 20/40; G06Q 40/02

(52) U.S. Cl. CPC G06Q 20/3276; G06Q 20/3223; G06Q 20/4016; G06Q 40/028

(57) ABSTRACT

Techniques for creation and use of electronic validation objects associated with physical instruments (e.g., physical documents used as negotiable instruments) are provided. Such techniques involve processes for creation of an electronic validation object, as well as uses of such objects to implement validation and audit processes associated with the underlying physical instruments, as well as conversion of physical instruments to/from digital representations to improve flexibility of use and exchange. Such processes may be used in conjunction with check issuance, tracking, and deposit processes to improve reliability and flexibility of transfer processes. This may include creation of a validation object useable for establishing an audit trail or initiating alternative payments, e.g., via realtime payment systems. Fraud detection processes, and improved tracking of account state are also provided. In some instances, physical instruments may be enhanced with two-dimensional codes useable with such validation objects.

### BACKGROUND

Users maintain accounts with various types of institutions. For example, a user may have healthcare accounts storing health records, digital identity accounts, legal accounts storing files, financial accounts (e.g., a checking account), other accounts, or combinations thereof. In each of these scenarios, a user may exchange or provide physical documents, such as a physical instrument, with another entity (e.g., a user identity card in the case of a health account, or financial instruments, such as physical checks or deposit slips in the case of a financial account, a car title, and the like).

In the case of a health account or a digital identity account, validation of a user may require presentment of a user identity card (e.g., a driver's license, insurance card, or the like) for verification. In some cases, this verification is simply a visual verification (e.g., by a receptionist at a clinic) where name and face are matched. While a user may be asked (e.g., at a time of an appointment) whether they have updated payment or insurance information, this may not be verified at the time of the appointment, thereby causing difficulty in later obtaining updated user information.

In the case of a financial account, and in particular a checking account, even greater presentment challenges exist, with respect to timing of verification and opportunities for fraud. Fraud may include, for example, fraud that exploits a time between exchange of a physical check and the time of funds exchange, or manipulation of physical characteristics of the check (e.g., modifying an amount written on the check, or name of payee). Nevertheless, certain individuals and organizations continue to prefer using physical checks for funds exchange. For example, checks are easy and inexpensive to use due to existing infrastructure. Many checks are processed via mobile deposit, which relies solely on images of checks.

Given the pervasiveness of document presentment occurrences, some types of self-authenticating documents (e.g., identification cards) have been modified over time to add security features suggesting that the document itself is genuine. However, other types of documents, such as financial instruments or other exchanged documents may be standardized across institutions and inclusion of security features may be limited. In these cases, such fraud continues to exist and fraudsters continue to attempt to find ways to circumvent safety controls on such physical instruments.

### SUMMARY

Aspects of the present disclosure relate to techniques for creation and use of electronic validation objects associated with physical instruments. Such techniques involve processes for creation of an electronic validation object, as well as uses of such objects to implement validation and audit processes associated with underlying physical instruments, as well as conversion of physical instruments to or from digital representations. Such processes may be used in conjunction with check issuance, tracking, and deposit processes to improve security, reliability, and flexibility of transfer processes.

In an example aspect, a system is disclosed. The system comprises a first mobile device associated with a check issuer; a second mobile device associated with a check recipient; a first server associated with a check issuer account; a second server associated with a check recipient account; wherein the first server is configured to: receive, from the first mobile device, a first check image of a check associated with a first visual appearance, a first amount, the check issuer account, and a first check recipient identity, wherein the first check image includes colors other than bitonal black and white; responsive to receiving the first check image, modify a record associated with the check issuer account based on the first amount; wherein the first mobile device is configured to: receive a first account balance inquiry from the check issuer regarding the check issuer account; responsive to receiving the first account balance inquiry, provide an account balance user interface showing: a first balance for the check issuer account based on the modified record, wherein the first balance is provided in a first user interface style; a first user interface element; detect actuation of the first user interface element; and responsive to detecting the actuation of the first user interface element, provide the first check image; wherein the first server is configured to: from the second server, receive check deposit data originating from the second mobile device, wherein the check deposit data is associated with a second amount, a second check recipient identity, and a second check image of the check having a second visual appearance, wherein the second check image of the check is a bitonal black-and-white image, wherein one or more of the second amount or the second check recipient identity is fraudulently altered; apply a fraud detection process comprising at least one of: (a) determining that the first amount and the second amount are not in accordance; (b) determining that the first check recipient identity and the second check recipient identity are not in accordance; or (c) determining that the first visual appearance and the second visual appearance are not in accordance; and based on one or more of (a)-(c), determine that the check deposit data fails the fraud detection process; responsive to the check deposit data failing the fraud detection process: deny a settlement of the check; void the check; and send an alert to the first mobile device that the check deposit data failed the fraud detection process; wherein the first mobile device is configured to: receive the alert from the first server; receive a second account balance inquiry from the check issuer regarding the check issuer account; responsive to receiving the second account balance inquiry, provide the account balance user interface showing a second balance for the check issuer account that accounts for the voided check, wherein the second balance is provided in a second user interface style different from the first user interface style; and responsive to detecting actuation of a second user interface element of the second user interface, provide the first check image and the second check image.

In an example aspect, a method is disclosed. The method comprises, at a server: receiving, from a first mobile device, a first check image of a check associated with a first visual appearance, a first amount, a check issuer account, and a first check recipient identity, wherein the first check image includes colors other than pure black and pure white; and responsive to receiving the first check image of the check, modifying a record associated with the check issuer account based on the first amount; at a mobile device: receiving a first account balance inquiry from a user regarding the check issuer account; responsive to receiving the first account balance inquiry, providing an account balance user interface showing: a balance for the check issuer account based on the modified record, wherein the balance is provided in a first user interface style; a first user interface element; detecting actuation of the first user interface element; and responsive to detecting the actuation of the first user interface element, providing the first check image; at the server: receiving check deposit data originating from a second mobile device, wherein the check deposit data is associated with a second amount, a second check recipient identity, and a second check image of the check having a second visual appearance, wherein the second check image of the check is a bitonal black-and-white image; applying a fraud detection process comprising: (a) determining that the first amount and the second amount are in accordance; (b) determining that the first check recipient identity and the second check recipient identity are in accordance; and (c) determining that the first visual appearance and the second visual appearance are in accordance notwithstanding color differences in the images; and based on steps (a)-(c), determining that the check deposit data satisfies the fraud detection process; and in response to the check deposit data satisfying the fraud detection process, approving a settlement of the check; at the mobile device: after approval of the settlement of the check, receiving a second account balance inquiry from the user regarding the check issuer account; and responsive to receiving the second account balance inquiry, providing the account balance user interface showing a second balance for the check issuer account that accounts for the settlement of the check and is provided in a second user interface style different from the first user interface style.

In an example aspect, a set of one or more non-transitory computer readable media having instructions is disclosed. Executing the instructions by a set of one or more processors causes the processor set to receive, from a first mobile device, a first check image of a check associated with a first visual appearance, a first amount, a check issuer account, and a first check recipient identity, wherein the first check image includes colors other than bitonal black and white; responsive to receiving the first check image, modify a record associated with the check issuer account based on the first amount; provide, to the first mobile device, a first balance of the check issuer account to be displayed in a first user interface style; from a second server, receive check deposit data originating from a second mobile device, wherein the check deposit data is associated with a second amount, a second check recipient identity, and a second check image of the check having a second visual appearance, wherein the second check image of the check is a bitonal black-and-white image, wherein one or more of the second amount or the second check recipient identity is fraudulently altered; apply a fraud detection process comprising at least one of: (a) determining that the first amount and the second amount are not in accordance; (b) determining that the first check recipient identity and the second check recipient identity are not in accordance; or (c) determining that the first visual appearance and the second visual appearance are not in accordance; and based on one or more of (a)-(c), determine that the check deposit data fails the fraud detection process; responsive to the check deposit data failing the fraud detection process: deny a settlement of the check; void the check; and send an alert to the first mobile device that the check deposit data failed the fraud detection process.

In an example aspect, a method is disclosed. The method comprises, at a check recipient mobile device: scanning a two-dimensional (2D) code printed on a check, wherein the check includes a first amount and a first check recipient identity; decoding the 2D code to determine an address encoded by the 2D code, the address being associated with a server; using the address, sending a request to the server; receiving, from the server, instructions to convert the check into a digital payment request; responsive to receiving the instructions, launching an application for generating the digital payment request; using the application, generating the digital payment request, the digital payment request including the first amount, the first check recipient identity, and an identifier associated with a check issuer of the check; using the application, sending the digital payment request to a first server associated with a first bank; after sending the digital payment request, providing instructions a user to physically alter the check such that the check resists representment fraud; and capturing an image of the altered check, the image showing that the check having been altered in accordance with the instructions; at the first server: receiving the digital payment request; based on the identifier, identifying the check issuer; determining that the check issuer provided approval for digital payment conversion; receiving the image of the altered check; verifying that the image shows the check having been altered in accordance with the instructions; and responsive to determining that the check issuer provided approval for digital payment conversion and further responsive to determining that the check was altered, voiding the check.

In an example aspect, a system is disclosed. The system comprises a check recipient mobile device; a web server; and a first server; wherein the check recipient mobile device is configured to: scan a two-dimensional (2D) code printed on a check, wherein the check includes a first amount and a first check recipient identity; decode the 2D code to determine an address encoded by the 2D code, the address being associated with the web server; using the web address, send a request to the web server; receive, from the web server, instructions to convert the check into a digital payment request; responsive to receiving the instructions, launch an application for generating the digital payment request; using the application, generate the digital payment request, the digital payment request including the first amount, the first check recipient identity, and an identifier associated with a check issuer of the check; using the application, send the digital payment request to the first server; wherein the first server is configured to: receive the digital payment request; using the identifier, retrieve a stored validation object associated with the check, wherein the stored validation object comprises a second amount and a second check recipient identity associated with the check, wherein the second amount and the second check recipient identity are received from a check issuer mobile device; determine that the first amount and the second amount are in accordance; determine that the first check recipient identity and the second check recipient identity are in accordance; approve the digital payment request; and responsive to approving the digital payment request, void the check, wherein a digital payment following approval of the digital payment request comprises a realtime payment separate from a check settlement process.

In an example aspect, a set of one or more non-transitory computer readable media having instructions is disclosed. Executing the instructions by a set of one or more processors causes the processor set to scan a two-dimensional (2D) code printed on a check, wherein the check is in a first physical configuration and includes a first amount and a first check recipient identity; decode the 2D code to determine an address encoded by the 2D code, the address being associated with a web server; use the web address, sending a request to the web server; receive, from the web server, instructions to convert the check into a digital payment request; responsive to receiving the instructions, launch an application for generating the digital payment request; using the application, generate the digital payment request, the digital payment request including the first amount, the first check recipient identity, and an identifier associated with a check issuer of the check; using the application, send the digital payment request to a first server associated with a first bank, wherein the first server approves the digital payment request and voids the check; obtain an image of the check in a second physical configuration that resists representment and resists transformation into the first physical configuration; and transmit the image of the check in the second physical configuration to the first server.

In an example aspect, a method is disclosed. The method comprises, at a check issuer mobile device: capturing an image of a check; detecting a presence of a two-dimensional (2D) code printed on the check, the 2D code being unique to a check issuer; extracting check data from the image of the check, the check data including at least an amount and a payee; and transmitting the image of the check and the check data to a first server associated with a check issuer account; at the first server: creating a validation record including the image of the check, the check data, and information extracted from the 2D code; modifying a record associated with the check issuer account based on the amount; and providing an account balance user interface illustrating a provisional change to an account balance for the check issuer account based on the modified record.

In an example aspect, a method is disclosed. The method comprises, at a check issuer mobile device: receiving a request to issue a check to a check recipient, the request including a payee name and an amount; receiving, via a user interface, a selection from among a digital check option and a physical check option; and receiving, via the user interface, an issuer signature to be included on the check; at a first server associated with a check issuer account: generating a 2D code to be printed on the check, the 2D code including at least one of (1) link information accessible by the check recipient to initiate a funds transfer operation, or (2) a code unique to the check issuer and check; generating a digital representation of the check including the payee name, amount, issuer signature, and the 2D code; providing a preview image including the digital representation of the check to the check issuer mobile device; and based on the digital representation of the check, issuing the check directly to the recipient, wherein the check includes at least one of a digital check or a physical check.

In an example aspect, a system is disclosed. The system comprises a check issuer mobile device; and a first server; wherein the check issuer mobile device is configured to: capture an image of a check; detect a presence of a two-dimensional (2D) code printed on the check, the 2D code being unique to the check issuer; extract check data from the image of the check, the check data including at least an amount and a payee; transmit the image of the check and the check data to a first server associated with a check issuer account; wherein the first server is configured to: create a validation record including the image of the check, the check data, and information extracted from the 2D code; modify a record associated with the check issuer account based on the amount; and provide an account balance user interface illustrating a provisional change to an account balance for the check issuer account based on the modified record.

### BRIEF DESCRIPTION OF THE DRAWINGS

FIG. 1 illustrates a system including a network that includes a document presenter, a document recipient, and an exchanged document, such as a document having features disclosed herein.

FIG. 2 illustrates a front of a check useable in accordance with example embodiments.

FIG. 3 illustrates a back of a check useable in accordance with example embodiments.

FIG. 4 illustrates an example method for registering a check.

FIG. 5 illustrates an example method for viewing an account balance and information associated therewith.

FIG. 6 illustrates an example method of processing checks that may include a 2D code printed thereon for one or more of registration, validation, or deposit.

FIG. 7 illustrates an example method including registering and validating a check.

FIG. 8 illustrates an example method for validating a check as part of a chain of custody of the check.

FIG. 9 illustrates an example fraud detection method.

FIG. 10 illustrates an example method for automatically detecting and rejecting a fraudulently modified check.

FIG. 11 illustrates an example method for detecting and rejecting a fraudulent check that is created.

FIG. 12 illustrates an example user interface of a mobile device illustrating an example account state.

FIG. 13 illustrates the example user interface of FIG. 12 after a pending check is registered.

FIG. 14A illustrates the example user interface of FIGS. 12-13 showing an audit trail of the pending check prior to deposit and settlement.

FIG. 14B illustrates an example user interface for a check issuer to approve or deny an attempted deposit of a presented check.

FIG. 15 illustrates the example user interface of FIG. 12 showing an updated account state after deposit and settlement.

FIG. 16 illustrates the example user interface of FIG. 12 after detection of fraud on the check, for example at a time of validation or deposit.

FIG. 17 illustrates operation of a user interface by a check issuer to view check images included in an audit record within an account associated with the check issuer.

FIG. 18 illustrates an example method for converting a check into electronic payment.

FIG. 19 illustrates an example method for converting a check into electronic payment.

FIG. 20 illustrates an example method for electronically generating and issuing a check.

FIG. 21 illustrates an example set of server instructions for execution of the electronic generation of a check as in FIG. 20.

FIG. 22 illustrates a user interface for electronic generation of a check.

FIG. 23 illustrates mobile device instructions for automatic capture of check information for purposes of registration, validation, or deposit.

FIG. 24 illustrates a user interface for automatic capture of check information in accordance with FIG. 23.

FIG. 25 discloses a computing environment with which aspects of the present disclosure may be implemented.

FIG. 26 illustrates an example machine learning framework that techniques described herein may benefit from or improve on.

### DETAILED DESCRIPTION

As indicated above, financial instruments like paper checks present relatively high risk for manipulation or other fraud by either the issuer of the check or the recipient. The ability to relatively easily manipulate checks for financial gain makes them attractive targets for fraud and other malfeasance. Further, attempts to reduce the risk are complicated by the existing need to standardize check features across institutions, which can limit the inclusion of security features. And sufficiently advanced features may defeat the very simplicity that makes checks an attractive means for transferring money. Even absent fraud, checks are difficult to account for because of processing delays. An issuer may write a check, but the amount is not reflected in the user's account balance until after the recipient negotiates the check (e.g., deposits or cashes it) and the associated institution contacts the issuer's bank for payment. This delay can be significant and leads to misleading account information being displayed to a user even absent fraud. Thus, there exists a need for technological innovation to address fraud risk and inconvenience while maintaining compatibility with existing infrastructure. Notably, although the instant disclosure may mention financial transaction, unless otherwise explicitly stated the disclosure is directed to technological solution for addressing problems (e.g., security vulnerabilities and inaccurate information) arising from transactions rather than the transactions themselves.

In accordance with examples of the present disclosure, technology for the use of electronic validation objects associated with physical instruments (e.g., physical documents used as negotiable instruments) are provided. Such technology involves processes for the creation of an electronic validation object, as well as uses of such objects to implement validation and audit processes associated with the underlying physical instruments, as well as conversion of physical instruments to and from digital representations to improve flexibility and security of use and exchange.

While the present disclosure provides as an illustrative example the case of an electronic validation object used in conjunction with a physical check issued by a check issuer and deposited or otherwise presented for payment by a check recipient, it is recognized that the concepts of the present disclosure may apply more broadly to other financial instruments or physical objects or documents used in a transaction, whether related to financial systems or otherwise. Accordingly, the present disclosure relates broadly to integration of an electronic validation object with such a physical document exchange.

In an example, a check issuer (e.g., the person writing the check out to another) takes a picture of a check, which is then processed by technology to resist fraud. For example, the picture of the check can be sent to the check issuer's bank. The check issuer's bank can then match the image against what a check recipient is attempting to negotiate (e.g., deposit or cash). Such matching can serve as verification to protect against attempting to negotiate a modified check. In further examples, the check may include a 2D code (e.g., a QR code) that the check issuer scans, which causes the scanning device to provide a form usable to register information about the check being sent, thereby adding further security. The issuer's bank can use this information to verify that it matches what a check recipient is attempting to negotiate and thereby provide enhanced detection of fraudulent checks. The 2D code may encode a link that leads to a portal for logging into an account using bank credentials associated with the check issuer. That way, if the issuer does not use the 2D code to protect against fraud, the check recipient cannot scan it and fraudulently register the check by impersonating the check issuer. In some embodiments, a single picture can include the check and the 2D code. In some embodiments, processing on the imaging device (e.g., a phone) identifies the 2D code and sends the picture that was taken to a server or application indicated by a URL encoded in the 2D code. In addition to security, this 2D code process also advantageously lets the issuer of the check have their checking account balance automatically updated to avoid the inaccuracy that occurs with checks not being reflected in an available balance.

In an example, a method of uploading a paper check into an electronic system is disclosed. The method can be used in connection with checks that include enhanced security features, such as a 2D code printed thereon, and checks that do not have enhanced security features. For example, a check issuer can write a check and launch check capture software, which may include a camera application or another mobile application. In some embodiments, the issuer device uses the anchor points printed on the check for recognition and rapid alignment of the check, and the issuer device captures an image of check. The issuer device uses optical character recognition (OCR) to extract data from the check, which can include printed and handwritten information. In some embodiments, the check includes a second 2D code printed thereon. The image processing technology on the issuer device can recognize the second 2D code and extract the data encoded by the second 2D code. The data encoded by the second 2D code may be an identifier of the check or check issuer. The issuer device can connect the second 2D code and its encoded data to the image and other data extracted from the check.

Continuing with the example, image and extracted data are transmitted from the device to one or more backend bank systems. The collective check data that is stored in the system of record is used to generate a validation object associated with the check. The validation object may contain the captured image along with the collective data extracted from the check. In some embodiments, the validation object can be encoded back to the data matrix that was printed on the original check. The validation object can be used for check validation, check processing, and enhanced security features. Further, the validation object can be associated with a status of the check (paid, outstanding, stopped, voided, etc.) Data associated with the validation object can be provided back to the check issuer through a digital user interface registry in the form of a pending payment entry in the transaction history for their account. Using the registry, the user can track and manage the status of the outstanding check. Once settled, the status automatically updates, and the check moves to the transaction history. Additionally, a summary of the validation object can be sent to the recipient of the check.

In an example, a method for validating a check with a corresponding validation object is disclosed. In some embodiments, any holder of the check can launch a check validation user interface, including the ultimate check recipient or an intermediate party. The check validation user interface leverages an image capture device to capture a point in time image of the check. The mobile device uses OCR to extract all the data from the check, including printed and handwritten information, which are transmitted from the device to the bank systems. The collective check data that is stored in the system of record is used to generate a second digital record corresponding to the check that contains the captured image along with the collective data extracted from the check. The system compares the second digital record to a validation object and generates a status report, such as a payment status and whether there is match with the original. The status report is returned to the user through a user interface. In some embodiments, the mobile device can request and receive the validation object, and the validation steps can be completed on the mobile device with the digital record and status summary being transmitted back to the bank system after validation on the device, a process that may increase the speed at which validation is performed and decrease utilization of the computer resources at the bank system. In some embodiments, in addition to validating the check, the system may also settle the check in response to a positive validation. Further, if the validation is unsuccessful, then the check may not be settled and may be voided.

In an example disclosed herein, a 2D code, such as a QR code, is printed on a check. The check recipient can scan the 2D code and initiate a request for payment. This request converts the check into a digital payment request that is routed to the issuer of the check. In an example, the recipient takes a picture of the entire check, and systems disclosed herein use the information on the check to create and pre-fill the payment request that is sent to the check issuer. The check issuer can then accept the request (which causes a banking server associated with the check maker to void the check) or deny it, in which case the check can still be otherwise used. The image of the check can be sent to the issuer with the request to convert the payment format for them to approve. The 2D code can be unique to the check, the check maker, or a combination thereof. For example, at the time of printing, an identifier may be encoded by the 2D code, thereby tying the check to the check maker at the time of printing. That way, when the payment is converted to another format, such as a digital payment request that specific check number can be voided (e.g., made to be invalid or no longer valid).

In an example, a method of generating an electronic check using an electronic device is disclosed. For example, using a mobile or web application, an electronic check issuer may input a check amount and enter payee information or select a payee from a list. The check data and payee information may be sent to a backend system associated with the check issuer's bank. The system generates a code that may encode information associated with the issuer's identification, account number, check number, check recipient information, amount, date, geolocation, or other information. The system prepares a preview of the electronic version of the electronic check, which includes the code. Once confirmed by the user, a validation object is created that can represent a digital record of the check. The check issuer may have the option to generate a paper version (to be mailed) or an electronic version of the check that can be electronically delivered to the recipient. Additionally, the electronic version can be sent with a code having instructions for the recipient on how to negotiate or request a paper version.

In an example, a method of detecting a check using only the image capture device and then launching a user interface is disclosed. For example, a user can launch a check deposit process by opening a camera of a device and scanning a check. Computer vision technology can automatically recognize the check, and in response, generate a link that leads to a mobile check deposit process provided by a web application or a mobile application.

### General System

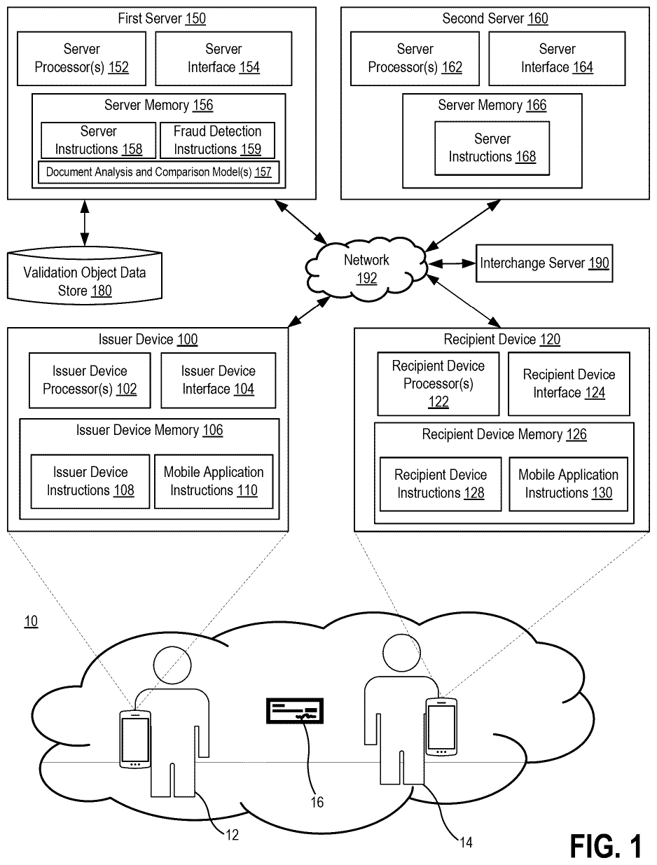

An example system that can be used according to examples herein is described in FIG. 1. FIG. 1 illustrates a system 10 configured to, among other things, facilitate secure exchange of a document.

The system 10 includes an issuer device 100, a recipient device 120, a first server 150, a second server 160, and an interchange server 190 connected to a network 192. Further, the system 10 includes an issuer 12, a recipient 14, and a document 16.

The issuer 12 may be a person, machine, or other entity that writes, makes, signs, originates, or otherwise performs an operation associated with creating the document 16. The issuer 12 may use the issuer device 100. For example, if the document 16 is a check, then the issuer 12 is often the entity that fills in the fields of a blank check and provides the blank check to the recipient 14. The issuer 12 may be a customer of, or otherwise may be associated with, an entity that owns, operates, or otherwise controls the first server 150 and the components associated therewith.

The recipient 14 may be a person, machine, or other entity that receives the document 16. In some instances, the recipient 14 is the final recipient of the document 16. For example, if the document 16 is a check, then the recipient 14 is often the person to whom the check is written. In some examples, the recipient 14 is merely a person coming into physical possession of the document 16 without necessarily being the issuer or intended recipient. For instance, the recipient may be a fraudster that intercepts the document 16 (e.g., by stealing it from a mailbox). That fraudster may then attempt to modify the document 16 such that the fraudster can negotiate the document 16 or trick others into believing that the fraudster is an authorized recipient of the document 16. In some instances, the recipient 14 is an intermediary. For example, the recipient 14 may receive the document 16, perform one or more operations associated with the document 16, and then provide the document 16 to a subsequent recipient. The recipient 14 may use the recipient device 120. The recipient 14 may be a customer of, or otherwise may be associated with, an entity that owns, operates, or otherwise controls the second server 160 and the components associated therewith.

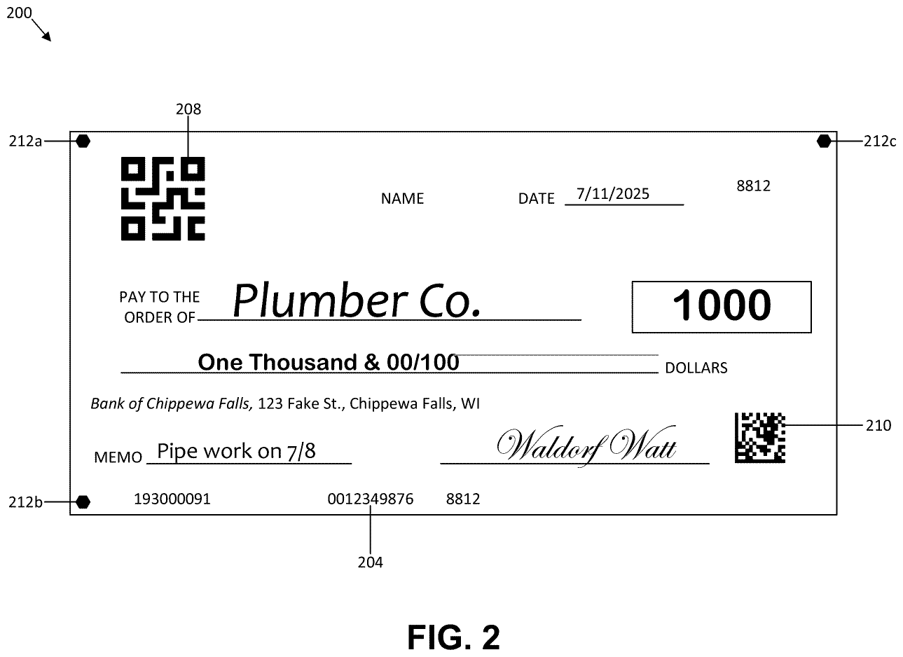

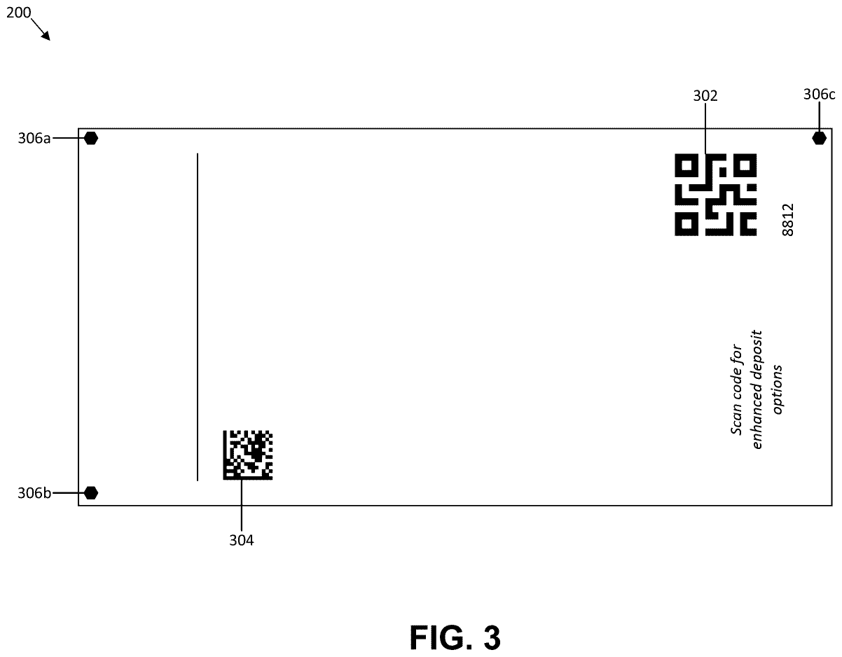

The document 16 is provided from the issuer 12 to the recipient 14. The document 16 can be a physical document, an electronic document, or a combination thereof. The document 16 may include sensitive security or financial information. In some instances, information on the document 16 can be fraudulently altered. In some embodiments, the document 16 is a check, an example of which is illustrated and described in connection with FIGS. 2-3. However, even for embodiments in which the document 16 is a check, the document 16 can be different from the check described in connection FIGS. 2-3. For example, the check may not include a 2D code printed thereon. Although frequently referred to herein as a check, the document 16 can be a document other than a check. For example, in some embodiments, the document 16 may be a contract, letter, will, invoice, identity card, or other physical or digital written instrument.

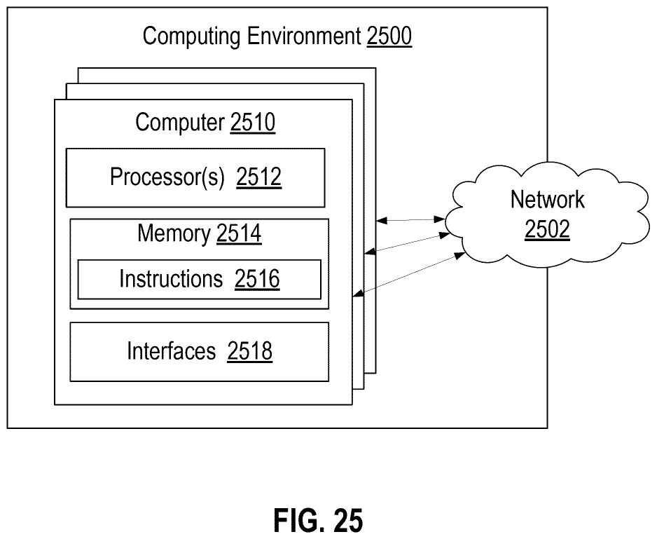

The issuer device 100 is a device used by the issuer 12 that can be used as part of processes described herein. The issuer device 100 can include one or more aspects described elsewhere herein such as in reference to the computing environment 2500 of FIG. 25. In many examples, the issuer device 100 is a personal computing device, such as a smart phone, tablet, laptop computer, or desktop computer. But the issuer device 100 need not be so limited and may instead encompass a plurality of devices used by a user as part of processes described herein. In the illustrated example, the issuer device 100 can include an issuer device processor set 102, an issuer device interface set 104, and an issuer device memory set 106, among other components.

The issuer device processor set 102 is a set of one or more processors. One or more processors are components of the issuer device 100 that execute instructions, such as instructions that obtain data, process the data, and provide output based on the processing. The issuer device processor set 102 can include one or more aspects described below in relation to the processor set 2512 of FIG. 25.

The issuer device interface set 104 is a set of one or more interfaces, which are one or more components of the issuer device 100 that facilitate receiving input from and providing output to something external to the issuer device 100. The issuer device interface set 104 can include one or more aspects described below in relation to the interface set 2518 of FIG. 25.

The issuer device memory set 106 is a set of one or more memory components, which are components of the issuer device 100 configured to store instructions and data for later retrieval and use. The issuer device memory set 106 can include one or more aspects described below in relation to the memory 2514 of FIG. 25. As illustrated, the issuer device memory set 106 stores issuer device instructions 108 and mobile application instructions 110.

The issuer device instructions 108 are a set of instructions that, when executed by the issuer device processor set 102, cause the device processor set 102 to perform an operation described herein. The instructions 108 may include, for example, instructions for one or more applications installed on the issuer device 100, such as a web browser, a camera application, an image processing application, or other applications. For instance, in some examples, the instructions 108 are instructions that cause a web browser of the issuer device 100 to render a web page associated with a process described herein. The web page may present information to the user and be configured to receive input from the user and take actions in response thereto. Further, the instructions 108 may include instructions associated with an operating system of the issuer device 100. In examples, the instructions 110 can be those of a mobile application (e.g., that may be obtained from a mobile application store, such as the APPLE APP STORE or the GOOGLE PLAY STORE). The mobile application can provide a user interface for receiving user input from a user and acting in response thereto. In some embodiments, the mobile application is provided by an entity that is associated with the first server 150. For example, the mobile application may be a banking mobile application. The user interface can further provide output to the user.

The recipient device 120 is a device used by the recipient 14 that can be used as part of processes described herein. The recipient device 120 can include one or more aspects described elsewhere herein such as in reference to the computing environment 2500 of FIG. 25. In many examples, the recipient device 120 is a personal computing device, such as a smart phone, tablet, laptop computer, or desktop computer. But the recipient device 120 need not be so limited and may instead encompass a plurality of devices used by a user as part of processes described herein. In some examples, the recipient device 120 is a specialized computing device, such as a point of sale device, an automated teller machine, or a check processing device. In the illustrated example, the recipient device 120 can include a recipient device processor set 122, a recipient device interface set 124, and a recipient device memory set 126, among other components.

The recipient device processor set 122 is a set of one or more components of the recipient device 120 that execute instructions, such as instructions that obtain data, process the data, and provide output based on the processing. The device processor set 122 can include one or more aspects described below in relation to the processor set 2512 of FIG. 25.

The recipient device interface set 124 is a set of one or more interfaces, which are one or more components of the recipient device 120 that facilitate receiving input from and providing output to something external to the recipient device 120. The recipient device interface set 124 can include one or more aspects described below in relation to the interface set 2518 of FIG. 25.

The recipient device memory set 126 is a set of one or more components of the recipient device 120 configured to store instructions and data for later retrieval and use. The recipient device memory 126 can include one or more aspects described below in relation to the memory 2514 of FIG. 25. The recipient device memory 126 can store recipient device instructions 128 and mobile application instructions 130.

The recipient device instructions 128 are a set of instructions that, when executed by the processor set 122, cause the processor set 122 to perform one or more operations described elsewhere herein. The instructions 128 may include, for example, instructions for one or more applications installed on the recipient device 120, such as a web browser, a camera application, an image processing application, or other applications. For instance, in some examples, the instructions 128 are instructions that cause a web browser of the recipient device 120 to render a web page associated with a process described herein. The web page may present information to the user and be configured to receive input from the user and take actions in response thereto. Further, the instructions 128 may include instructions associated with an operating system of the recipient device 120. In examples, the instructions 130 can be those of a mobile application (e.g., that may be obtained from a mobile application store, such as the APPLE APP STORE or the GOOGLE PLAY STORE). The mobile application can provide a user interface for receiving user input from a user and acting in response thereto. In some embodiments, the mobile application is provided by an entity that is associated with the first server 150 or the second server 160. The user interface can further provide output to the user.

The first server 150 is a server device that functions as part of one or more processes described herein. The first server 150 can be part of an information system of an entity. For example, the first server 150 may be part of a backend infrastructure of the entity. The entity may be, for example, an organization. In some embodiments, the entity is a bank. In the illustrated example, the server 150 includes a server processor set 152, a server interface set 154, and a server memory set 156, among other components.

The server processor set 152 is a set of one or more processors that are components of the server 150 that execute instructions, such as instructions that obtain data, process the data, and provide output based on the processing. The server processor set 152 can include one or more aspects described below in relation to the processor set 2512 of FIG. 25.

The server interface set 154 is a set of one or more components of the server 150 that facilitate receiving input from and providing output to something external to the server 150. The server interface set 154 can include one or more aspects described below in relation to the one or more interfaces 2518 of FIG. 25.

The server memory set 156 is a collection of one or more components of the server 150 configured to store instructions and data for later retrieval and use. The server memory set 156 can include one or more aspects described below in relation to the memory 2514 of FIG. 25. The server memory 156 can store server instructions 158, one or more document analysis and comparison models 157, and fraud detection instructions 159.

The server instructions 158 are instructions that, when executed by one or more processors of the processor set 152, cause the processor set 152 to perform one or more operations described herein. The fraud detection instructions 159 are instructions that, when executed by the one or more processors of the processor set 152, cause the first server 150 to perform operations associated with detecting and preventing fraud. Such operations may include managing validation objects, comparing incoming data against validation object, and communicating with external components, processes which are further described herein. In some instances, executing the fraud detection instructions 159 comprises applying one or more of the document analysis and comparison models 157. The models 157 may be one or more computer vision models, examples of which are described further herein.

The second server 160 is a server device that functions as part of one or more processes described herein. The second server 160 can be part of an information system of an entity. For example, the second server 160 may be part of a backend infrastructure of the entity. The entity may be, for example, an organization. In some embodiments, the entity is a bank. In some embodiments, the bank provides services to the recipient 14, such that the second server 160 stores data associated with a check recipient account. In some embodiments, the entity associated with the second server is different from the entity associated with the first server. For example, the entity associated with the first server and the entity associated with the second server may be different banks that belong to a consortium. In some instances, however, the first server 150 and second server 160 belong to a common information system associated with a common entity. For example, the first server 150 and the second server 160 can be part of a backend infrastructure of the same bank. In the illustrated example, the server 160 includes a server processor set 162, a server interface set 164, and a server memory set 166, among other components.

The server processor set 162 is a set of one or more processors that are components of the server 160 that execute instructions, such as instructions that obtain data, process the data, and provide output based on the processing. The server processor set 162 can include one or more aspects described below in relation to the processor set 2512 of FIG. 25.

The server interface set 164 is a set of one or more components of the server 160 that facilitate receiving input from and providing output to something external to the server 160. The server interface set 164 can include one or more aspects described below in relation to the one or more interfaces 2518 of FIG. 25.

The server memory set 166 is a collection of one or more components of the server 160 configured to store instructions and data for later retrieval and use. The server memory set 166 can include one or more aspects described below in relation to the memory 2514 of FIG. 25. The server memory 166 can store server instructions 168.

The server instructions 168 are instructions that, when executed by one or more processors of the processor set 162, cause the processor set 162 to perform one or more operations described herein.

The validation object data store 180 comprises one or more of a database, data table, or data storage system that stores validation objects. Each validation object may correspond to a check and may include data corresponding to the check. A validation object may include one or more of the following: check issuer identity; check recipient identity; amount; check status; one or more visual appearances, such as images of the check, wherein the images may include a bitonal black-and-white image and a color image; date; memo; check issuer account number; signature; or other data input by the issuer, printed on the check, written on the check, or derived from the check. Additionally, the validation object may include data associated with its creation, such as a time when the check was registered and a place from which the check was registered, which may be determined using GPS data from the issuer device 100. Furthermore, the validation object may include data about how it has been used, such as validation records. For example, the validation object may include data indicating that one or more previous check deposit attempts had failed or succeeded. Relatedly, the validation object may store digital records that are associated with such attempts, such as a requesting bank identity or recipient identity, a time, and an image of the check when it was deposited.

The interchange server 190 is a server associated with a third-party payment network. For example, the interchange server 190 may facilitate the generation and execution of digital payment requests. The interchange server 190 may be communicatively coupled with servers associated with banks, such as the first server 150 and second server 160, to settle digital payments initiated by users, such as the issuer 12 or the recipient 14. In some instances, users access the interchange server 190 via their respective banking servers. In other instances, users may directly access the interchange server 190. In some embodiments, the interchange server 190 provides an application that can be executed by the issuer device 100 or the recipient device 120 as part of facilitating the creation and settlement of digital payment requests. The application may be a mobile application or a web application. In some embodiments, a 2D code printed on a check encodes a link to an application provided by the interchange server, thereby enabling a check recipient to convert a physical check into a digital payment request, as is further described below.

The network 192 is a set of devices that facilitate communication from a sender to a destination, such as by implementing communication protocols. Example networks 192 include local area networks, wide area networks, intranets, the Internet, or a combination thereof.

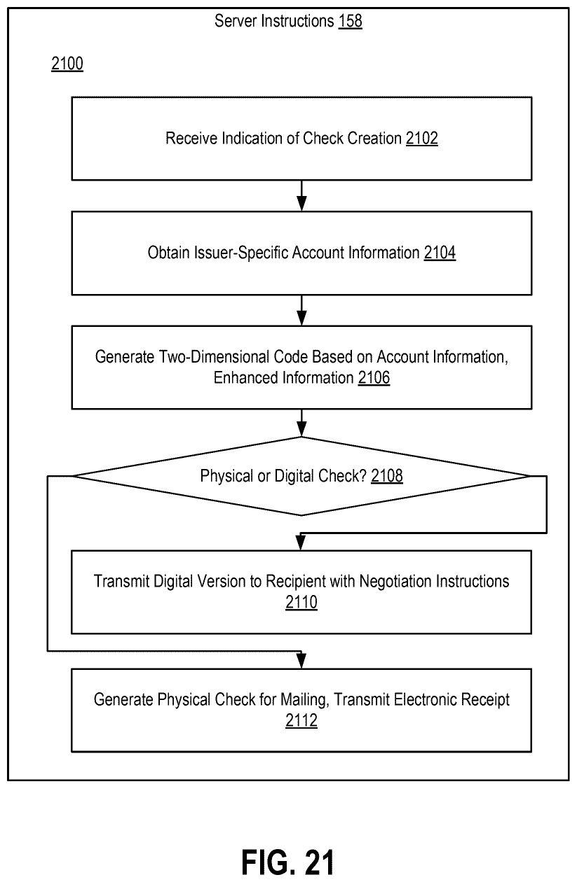

FIG. 2 illustrates a front of a check 200 configured for use in accordance with example embodiments. The check 200 is an example of the document 16 of FIG. 1. The check 200 can be physical check or a digital check. In some examples, a physical check 200 may have a digital counterpart (or vice versa). The check 200 may be written by the issuer 12. For instance, in the example shown, the issuer 12 is an individual named “Waldorf Watt.” The check may be associated with a bank (e.g., as illustrated the “Bank of Chippewa Falls”), such as a bank with which the first server 150 is associated. As shown, the check 200 includes information printed thereon. Some information on the check is pre-printed by a bank (or a printing company associated therewith) before being received by the issuer (e.g., often in a checkbook), such as a routing number (“193000091”) and a check number (“8812”), as well as fields into which the issuer can provide information. Some information written by the issuer 12 includes a check recipient identity (“Plumber Co.”), a check amount (“1000”), a memo (“Pipe work on July 8”), a date (“Jul. 11, 2025”), and a signature. Furthermore, in the example shown, the check 200 includes an account number 204, a First code 208, a second code 210, and anchor points 212a-c, which can be pre-printed before the check is provided to the issuer. In some embodiments, operations described in connection with the method 2100 of FIG. 21 can be used to generate components of the check 200.

The account number 204 may be an account number associated with the issuer 12 at the bank or be merely associated with the bank of the issuer. As one example, the account number 204 may identify an account, such as a checking account, that the issuer 12 has with the bank. Advantageously, however, the account number 204 can be a number that does not identify an account of the issuer 12. For example, even though the issuer 12 may have an account at the bank with which the check 200 is associated, the account number 204 may be a generic number that is associated with the bank and is not specific to the issuer 12. As a result, the account number specific to the issuer 12 is not printed on the check, thereby remediating a security vulnerability of certain checks. In some embodiments, there is no account number 204 printed on the check 200 at all.

The check 200 can include one or more codes printed thereon. In the example shown, the check 200 includes both a first code 208 and second code 210. The first code 208 and the second code 210 may each be a different type of machine-readable code. While in many examples, the machine-readable code is a one-dimensional barcode or a two-dimensional data matrix. In some examples, the machine-readable code is pseudo-three-dimensional in that the code changes based on the perspective of the viewer (e.g., a person's eye or a camera), such as by being based on lenticular or holographic printing techniques. Such a pseudo-three-dimensional code can be harder to forge and can be used as a kind of “liveness” check to detect a real-life check from a digitally produced one (e.g., using a generative artificial intelligence) by determining that the code changes as expected in response to movement. In an example, the first code 208 and the second code 210 can each be different codes selected from the group consisting of a QR code, a data matrix, a bar code, or another kind of code. In some embodiments, a single code printed on the check 200 can encode the information described herein as being encoded by the first code 208 and the second code 210. In some embodiments, data encoded by the first 208 and the second code 210 may be encoded when the check 200 is printed. In some instances, however, the data is written to the first code 208 and the second code 210 as part of a registration process.

In an example, the first code 208 encodes an address to an application or site. For example, the first code 208 may be a QR code that encodes a URL to a web site or web application that is provided by one or more of the first server 150, the second server 160, or the interchange server 190. As another example, the first code 208 may include a deep link to a mobile application, such as a banking mobile application or to a mobile application store app to download a banking mobile application. In addition to providing an address to an application, the first code 208 may encode data that identifies one or more of the issuer, the issuer account, or the check.

In an example, the second code 210 encodes data that identifies the check. For example, the second code 210 may encode an alphanumeric string that identifies the check as belonging to the issuer 12 and that uniquely identifies the check from among all of the checks of the issuer 12. Furthermore, the second code 210 may encode other information on the check, such as a check recipient identity, amount, account number, memo, bank information, routing number, date, or other information that is written or printed on the check. The information may be limited to information that is known at the time the check is printed, which can vary. For instance, typical personal checks are printed without knowing the recipient, amount, or memo and so such information may be absent from the second code 210. But certain institutional checks (e.g., tax refunds or stimulus checks) may be printed with a particular recipient, amount, and memo being known and can include that information when the second code 210 is printed.

The anchor points 212a-c are marks printed on the check that can assist with scanning, image capturing, and image processing of the check, such as during a mobile check deposit process. In the example shown, the check includes three anchor points 212a-c that are printed on corners of the check 200. In some embodiments, the anchor points are used by an image processing process to perform one or more of check identification or alignment.

In some embodiments, the check 200 lacks some of the components described in connection with FIG. 2. Nevertheless, operations described herein may still be used with the check 200 that lacks certain components. For example, the check 200 may not include the first code 208, the second code 210, or any code.

In some embodiments, the check 200 may further include a watermark (e.g., a digital or physical watermark). The watermark may be used to verify the authenticity of the check. The watermark may be concealed, such that the watermark cannot readily be detected without software configured to detect the watermark. During a fraud detection process, the first server 150 can verify that a watermark is present in an image of a check that is being negotiated. In some embodiments, the anchor points 212a-c are part of the watermark. In an example, the watermark is generated and applied using one or more steganographic techniques.

FIG. 3 illustrates a back of the check 200 useable in accordance with example embodiments. In the example shown, the check 200 includes an endorsement line, a third code 302, a fourth matrix 304, and anchor points 306a-c.

In some embodiments, the codes printed on the back of the check 200 encode the same data as the codes printed on the front of the check. For example, the third code 302 encodes the same data that is encoded by the first code 208 printed on the front of the check 200. Similarly, the fourth code 304 may encode the same data that is encoded by the second code 210 that is printed on the front of the check 200. However, the codes printed on the back of the check 200 may provide additional security measures.

For example, a security vulnerability exists whereby some fraudsters may attempt to deposit a check by taking a first picture of the front of the check and then a second picture of the back of a different check that has been endorsed. That way, the fraudster attempts to deposit the check without having endorsed it. However, by using codes on the back of the check that encode data corresponding to the data encoded by codes on the front of the check, such fraud can be prevented. For example, the server 150 can verify that an identifier encoded by a code on the front of the check matches an identifier encoded by a code on the back of the check, thereby preventing a fraudster from using a front of a first check and a back of a second check as part of an attempted fraudulent deposit. As another example, data encoded by one or more or the codes 302 or 304 may be protected by a security mechanism that is different from the codes printed on the front of the check. For example, whereas one or more codes on the front of the check may be modifiable or readable without decryption, the one or more codes on the back of the check may be immutable or only readable with a key. Additionally, one or more of the codes printed on the back of the check may be concealed. For example, the check may include a scratch-off material that conceals the code 302 or the code 304.

The anchor points 306a-c may be marks on the check 200 that can, like the anchor points 208a-c, assist with recognition and alignment of the check 200.

### Check Registration and Validation

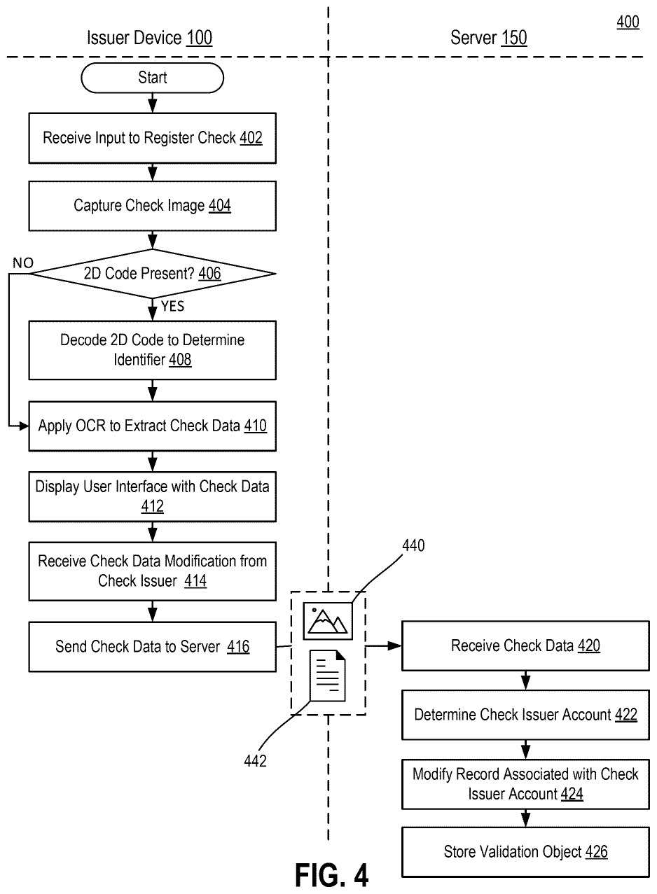

FIG. 4 illustrates an example method 400 for registering a check. In the example shown, operations of the method 400 can be performed by the issuer device 100 and the server 150. The method 400 can begin with operation 402.

Operation 402 includes an issuer device 100 receiving an input to register a check. For example, the issuer device 100 receives an input from the issuer 12 that is a request to register a check over the issuer device interface 104. The issuer device 100 may receive the input via a user interface of an application, such as a mobile application or a web application. The user interface may include a selectable option for registering a check, and the input may include a selection of the selectable option. As another example, the application can receive a voice command from the issuer 12 to register a check. As another example, the issuer device 100 may scan a 2D code on the check, such as the first code 208, which may encode a link to a check registration process. Therefore, scanning of the 2D code can be an input to register the check. Additionally, upon scanning the first code 208, the issuer 12 may be prompted with the option to register a check, and the issuer 12 can provide an input to proceed with a check registration process. In some embodiments, the issuer device 100, after receiving the input to register the check, instructs the user to capture an image of the check, to input check data, or both.

Operation 404 includes capturing a check image. For example, the issuer device 100 may use a camera to capture an image of the check. This can include capturing just the front of the check or both a front and a back of the check.

Operation 406 includes determining whether a 2D code is present. For example, the issuer device 100 analyzes the image of the check to determine whether a 2D code is present within the image. This can be performed using any of a variety of techniques, such as one or more recognition functions provided by OPENCV. In some embodiments, the issuer device 100 analyzes the check for a particular type of 2D code or for a 2D code in a particular location. For example, the issuer device 100 may determine whether a data matrix code is present. For instance, the issuer device 100 may be configured to detect a code that stores an identifier of the issuer 12 or of the check.

Following operation 406, if the 2D code is present, then the flow of the method 400 moves to operation 408. If the 2D code is not present, then the flow of the method moves to operation 410.

Operation 408 includes decoding the 2D code to determine a check identifier. The check identifier can be an alphanumeric string that identifies the check. The check identifier may include a unique identifier of the issuer 12 and also a check number, and when combined, these identifiers may provide a unique identifier of the check. In some instances, the check identifier only identifies the check, and the information identifying the issuer 12 is extracted from other parts of the check. In some embodiments, the check identifier is encrypted and can only be decrypted if the issuer has securely logged into an application for registering checks. In some embodiments, the identifier encoded by the 2D code is different from a number printed on the check (e.g., one or more components of the MICR line). In some embodiments, such as when a 2D code is not printed in the check, the identifier may be extracted from other parts of the check. For example, a check number may be printed on the check and this number can be used as an identifier for the check.

Operation 410 includes applying OCR to extract check data. For example, applying OCR, the issuer device 100 may determine values for one or more of an amount, a check issuer account, a check recipient identity, a memo, a check number, an account number, a routing number, a date, a signature, and other information on the check.

Operation 412 includes displaying a user interface with check data. For example, the issuer device 100 may display at least some of the data that was extracted by applying OCR. Further the issuer device 100 may display an option to confirm that the extracted data is accurate and an option to modify the extracted data (e.g., if it is inaccurate).

Operation 414 includes receiving a modification of the check data from the issuer 12. For example, the issuer may change one of the values that was extracted by the issuer device. For instance, if the issuer 12 wrote that the amount of the check is “1100”, and if the extracted value of the check amount by applying OCR was incorrectly determined to be “1700”, then the user may correct the amount value. Furthermore, the issuer 12 may fill in data corresponding to the check data that was not extracted during OCR, or if OCR was not applied, then the issuer 12 may fill in all required values for the check. In some embodiments, the issuer device 100 requires the user to confirm or provide values for certain fields, while other fields may be optional. For example, the issuer device 100 may require the issuer 12 to confirm or provide values for a check recipient identity, an amount and a signature, whereas a memo may be optional. Irrespective of whether a modification of data is received from the issuer 12, the issuer device 100 may receive a confirmation from the issuer 12 that the check data is accurate and ready to be sent to the server 150.

Operation 416 includes sending check data to the server. For example, the issuer device 100 can send the check image 440 and check information 442 to the server 150. The check image 440 may be the image captured by the issuer device during the operation 404. The check image 440 may be a color image of the check. The check information 442 may include information displayed on the check. For example, the check information 442 can be the information extracted during OCR, combined with any modifications by the issuer 12. Further, the check information 442 can include information manually input by the issuer 12. Furthermore, the check information 442 can include an identifier of the check. The identifier may be a unique identifier of the check, such that the check can be identified across all checks of all users. The identifier may be the identifier determined during the operation 408.

Operations 420 includes receiving check data. For example, the server 150 may receive the check image 440 and the check information 442. Further, the server 150 may receive a request to register the check.

Operation 422 includes determining a check issuer account. In some embodiments, the server 150 determines the check issuer account based on an identity sent by the issuer device. For example, the issuer 12 may be logged into an account associated with the server 150, such that when the check registration request is sent, a check issuer account identifier is sent therewith. In some embodiments, the server 150 determines the check issuer account based on the check image 440 or check information 442 received from the issuer device 100. For example, the check issuer account number may be printed on the check or encoded by a 2D code on the check, and it may have been extracted by the issuer device 100 during the operation 408 or 410. As another example, the server 150 may extract the check issuer account by decoding a 2D code on the check or performing OCR on the check.

Operation 424 includes modifying a record associated with the check issuer account. The server 150 can update a database that stores data associated with the check issuer account to reflect the check data received by the issuer device. The check may be assigned a status, such as “pending”, which indicates that the issuer 12 has written the check, but the check has not been negotiated (e.g., cashed, deposited, or otherwise disposed of). The server 150 may modify an account record for the issuer to subtract an amount of the check from an available amount of money in the check issuer account. Furthermore, the server can add the check to a group of checks for the issuer 12 and can specifically add the check to a group of pending checks for the issuer 12. In some embodiments, modifying the record associated with the check issuer account comprises generating and storing a validation object associated with the check.

Operation 426 includes storing a validation object. For example, the server 150 can store a validation object in the validation object data store 180 that corresponds with the received check data. The validation object can include the check image 440, the check information 442, and the identifier of the check. After storing the validation object, the server 150 may send a confirmation to the issuer device 100.

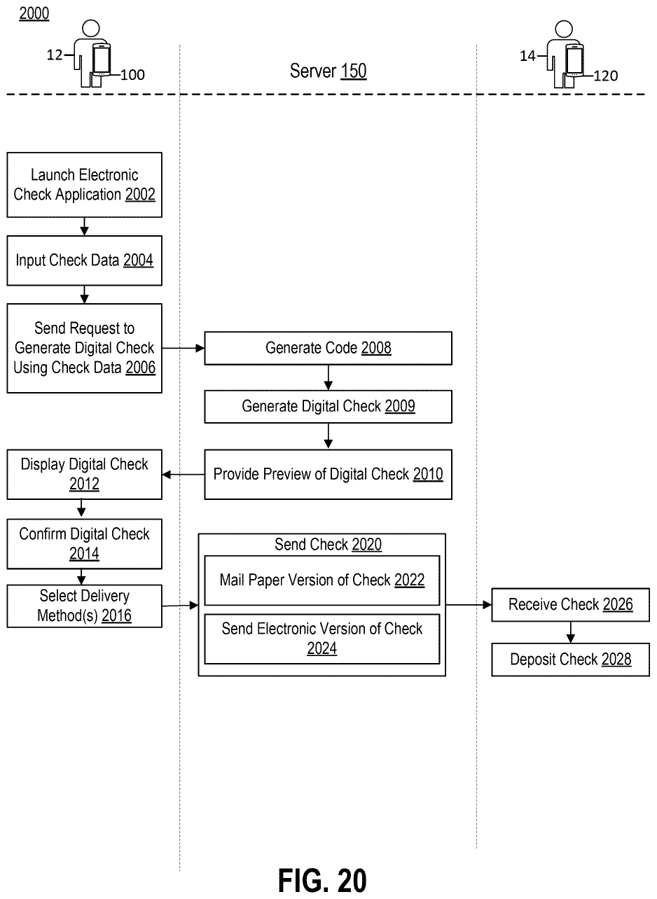

Although many of the operations of FIG. 4 were discussed with respect to a physical check, a person of skill in the art may modify one or more aspects to work with electronic versions of checks, such as is described in relation to FIG. 20, infra. For example, rather than capturing a check image with a camera, the check image may be a digital image loaded from memory on the device. The check data may already be present in computer-readable form such that OCR need not be performed on the check. In such an example, it may be beneficial to prohibit the modification of check data. In addition or instead, some or all of the data may already be present on the server as a result of the process of creating the electronic version and therefore need not involve (or need not involve as much) the issuer device 100. Likewise, techniques described herein may be applied to legacy billpay methods.

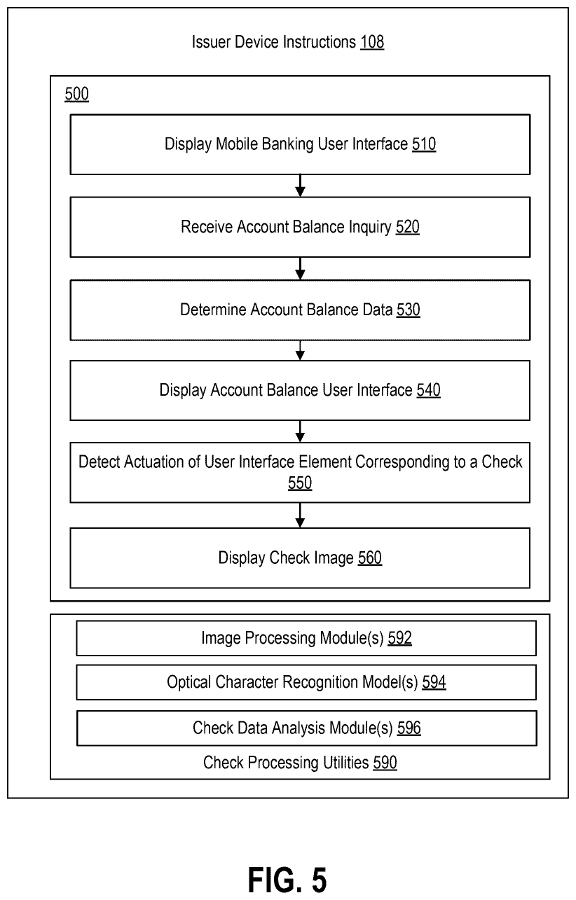

FIG. 5 illustrates an example of aspects of the issuer device instructions 108. In the example shown, the issuer device instructions 108 include an example method 500 that may be performed by the issuer device 100 and check processing utilities 590.

The method 500 includes example operations for viewing an account balance and information associated therewith. The method 500 can begin with the operation 510.

Operation 510 includes displaying a mobile banking user interface. The user interface may be displayed after a user (e.g., the issuer) has logged into an account. The user interface may include options to perform various mobile banking operations.

Operation 520 includes receiving an account balance inquiry. For example, via the user interface, the user device may receive a request to view account data from the user.

Operation 530 includes determining account balance data. For example, the issuer device 100 may query the server 150 to determine account balance data associated with the issuer 12, and account data may be returned by the server. The returned account data can include historical transactions of the issuer 12. Furthermore, the returned account data may include check data. The check data may include data for pending, settled, and void checks.

Operation 540 includes displaying an account balance user interface. The account balance user interface can include transactions for the user account. Each transaction can include a date and an amount. One or more of the transactions may correspond to checks. Each check may have a status, such as pending, settled, or void. Each check may be associated with a user interface element that is selectable to view further details of the check. For example, upon selection of a user interface element, one or more images of the check may be displayed. In an example, the information regarding pending checks can include information obtained as part of method 400, thereby providing more accurate and up-to-date information than a user interface that lacks such a feature.

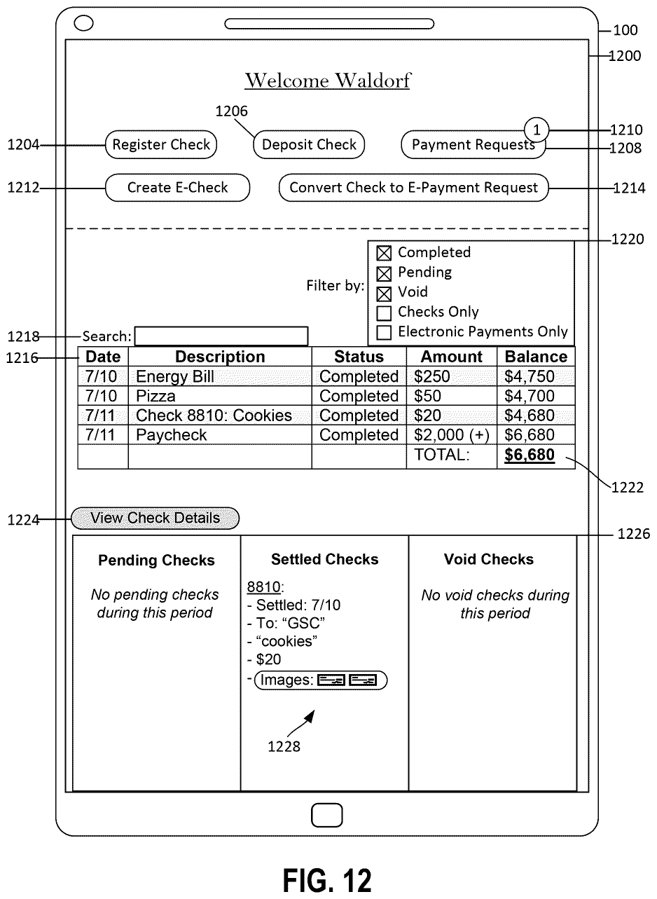

The account balance user may further include one or more balances. The balances may represent an amount of money after accounting for the transactions. In some instances, a balance reflects both settled and pending transactions. In some instances, a balance reflects only settled transactions. In some embodiments, when a balance reflects pending transactions, it may be displayed in a first user interface style to signal that it reflects pending transactions. For example, it may represent not the amount in the account, but the amount that would be in the account if the pending transactions were settled. The user interface style may include a font, size, italics, bolding, color, or other element that is different from a balance that does not reflect any pending transactions. In some embodiments, the user interface style of a balance may change when a pending check is settled, or when a new pending check is created and not yet settled. Examples of an account balance user interface are illustrated in FIGS. 12-17.

Operation 550 includes detecting actuation of a user interface element corresponding to a check. For example, the user may click a button or thumbnail that represents one or more images of the check.

Operation 560 includes displaying a check image. For example, in response to detecting the actuation of the user interface element, the issuer device may display one or more images associated with the selected check.

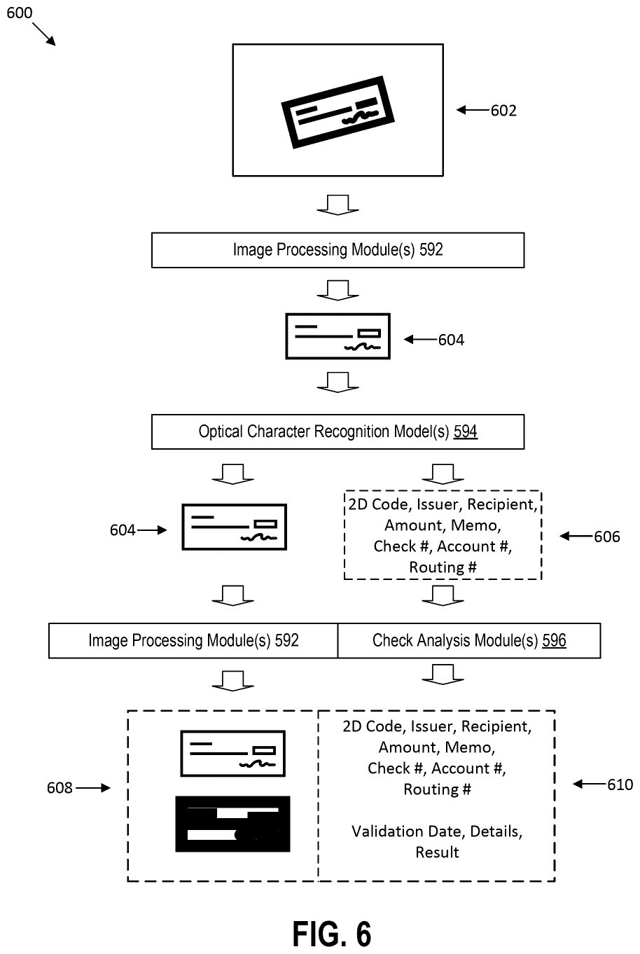

The check processing utilities 590 include components for processing a check image. In the example shown, the check processing utilities 590 include one or more image processing modules 592, one or more optical character recognition models 594, and one or more check data analysis modules 596. Though described as being implemented as part of the issuer device 100, one or more of the check processing utilities 590 can be implemented in the first server 150, the second server 160, the recipient device 120, or a third-party computing system. Example operations that may be performed by the check processing utilities 590 are described in connection with FIG. 6.

FIG. 6 illustrates an example image processing method 600 of a check, such as the check 200, for one or more of registration, validation, or deposit. In the example of FIG. 6, one or more of the check processing utilities 590 can be applied to a check image. In the example of FIG. 6, certain of the check processing utilities 590 are described as being applied by the issuer device 100. However, one or more of the check processing utilities 590 can be applied by another component of FIG. 1, such as the server 150, the server 160, or the recipient device 120. For example, the issuer device 100 may provide a check image to the first server 150, and each of the operations described in FIG. 6 can be performed by the first server 150. Additionally, combinations of computing components described in FIG. 1 can perform operations described in FIG. 6. For example, the issuer device may apply the image processing module 592 and the optical character recognition model 594, and the server 150 may apply the check analysis module 596 and perform further image processing. In these and other ways, the check image processing can flexibly be performed at different computing systems to match, for example, the available computing resources and run-time needs of the systems. Operations described in connection with the method 600 can be applied to implement image processing operations described herein.

In the example, shown, the issuer device 100 applies the image processing module 592 to process the check image 602. The check image 602 can include one or more of an image of the front of the check or an image of the back of the check. The one or more images may be captured by a camera of the issuer device 100. Applying the image processing module 592 can include applying an object detection model to identify the check within the image (e.g., and to separate it from the background). In some embodiments, the image processing module 592 identifies one or more indicia in the image to determine that the image includes a check. Such indicia may include, for example, the anchor points 212a-c described in connection with FIG. 2.

Applying the image processing module 592 can include using any of a variety of techniques, such as edge detection (e.g., as implemented in OPENCV), and then setting the boundaries of the check within the check image to a polygon that has an expected check aspect ratio. This can be performed or enhanced by using color, contrast, brightness or other kinds of identification. For instance, a check may have different visual characteristics compared to a table on which it is resting when the picture is taken. Such visual characteristics can be used to identify the check within the image. In another example, the boundaries can be determined by identifying the corners of the check, such as by using the anchor points 212a-c, and then connecting the corners with lines to form the boundaries.

Furthermore, applying the image processing module 592 can include normalizing the check within the image. This normalization processing can include normalizing the position or proportions of the check by, for example, skewing, deskewing, rotating, scaling, stretching, moving, or applying other transformations to the check within the check image to bring the check closer to an expected or standard format on which other steps may depend. This can include cropping the image so substantially only the check is within the check image. The normalizing can be based on the check boundaries identified above. This can also include normalizing the check to have a predetermined aspect ratio. Normalizing the check within the check image can further include adjusting image quality of the check image, such as modifying brightness, contrast, levels, sharpness, or other modifications.

In still further examples, applying the image processing module 592 can include removing backgrounds from the check image. If the check was placed on a table or surface by the user to capture the check image, the background containing the table or surface can be removed, blurred, filled, or otherwise modified. The brightness of the check image can also be adjusted to obtain an improved image brightness for performing OCR on the check image. Defects detected in the check image can be removed.

Applying the image processing module 592 can include saving multiple versions of the check image at a mobile device. For instance, an original color image can be stored in addition to a bi-tonal TIFF (Tag Image File Format) formatted image. Thus, the image processing module 592 can include a TIFF image generation module configured to convert the original color check image into a grayscale or black-and-white TIFF image. The color image can be saved in a specified format, such as TIFF, JPEG (Joint Photographic Experts Group), PNG (Portable Network Graphics), PDF (Portable Document Format), or another format.

In the example shown, the issuer device 100 applies the OCR model 594 to the image data 604 output by the image processing module 592. The OCR model 594 can extract text from the check image and recognize characters of the extracted text to generate OCR data. The OCR engine can take any of a variety of forms. In some instances, the issuer device 100 causes OCR to be performed by a software OCR process hosted by a third party (e.g., via AMAZON TEXTRACT, GOOGLE CLOUD VISION API, MICROSOFT AZURE AI SERVICES), a manual OCR process hosted by a third party or locally (e.g., the user of the issuer device 100 is asked to manually enter all characters in the image), or using a library stored and run locally. In an example, OPENCV can be used to recognize characters. In some examples, there is a machine learning framework trained to receive an image (e.g., part or all of the check image) and provide recognized characters as output.

The OCR model 594 analyzes regions within the check image to identify check data fields such that the generated OCR data includes an indication of check fields and data associated with each check field. For example, the OCR model 594 is configured to recognize a region of the check as an amount box, so the OCR model 594 can determine that the text within that region corresponds with the check amount. In another example, expected fields can be used to determine which side of a check is depicted in the image. In a further example, whether all expected fields can be identified can be used to determine whether the required check data is present. Example front check image expected fields can include one or more of an issuer information field, a recipient name field, a date field, a check amount in words field, a memo field, and a MICR line data field. Example back check image expected fields can include an endorsement field. These fields can be identified using various techniques including OCR. For instance, a field can be identified and a bounding box can be drawn around the field. The bounding box can then be used as a region in which OCR will be performed to determine a value associated with that field. In some examples, the fields can be identified using known check templates.

For example, the OCR model 594 may use known check templates to determine regions on a check image where check data is be expected. For instance, because many checks may have similar formats (e.g., the relative positioning of fields and other content) that can be predetermined and labeled (e.g., manually or with an automated process), identifying that the check image contains an image of a check having a predetermined pattern can be used to identify or know that expected fields are present (e.g., because otherwise the template would not match). The check image can be compared to the known check templates to determine a format that the check follows. When a match is found between a known check template and the check image, the matching known check template can be used during the OCR process to correlate the extracted text with the corresponding check field based on the location of the extracted text on the check. This improves the accuracy of the OCR process to generate OCR check data. In some embodiments, the OCR model 594 applies a template having the 2D codes and other features described in connection with the check 200 of FIGS. 2-3.

In the example shown, the OCR model 594 can output the extracted data 606, which can include one or more of the following: an image of one or more 2D codes; data extracted from one or more 2D codes; check issuer data, check recipient data, a numerical amount, an alphabetic amount, a memo, a check number, an account number, and a routing number.

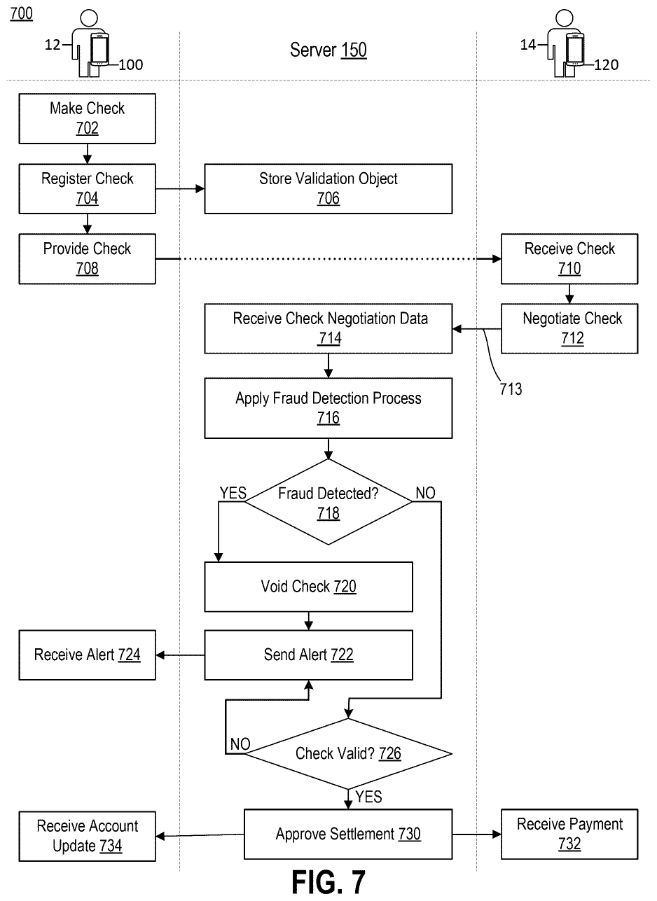

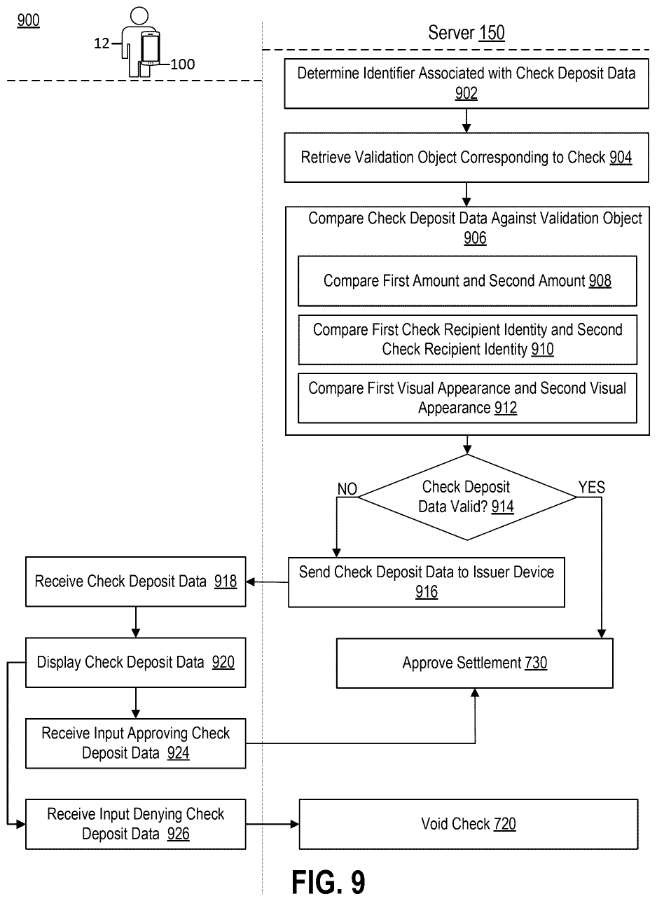

In the example of FIG. 6, further processing may be performed on the image data 604 and the extracted data 606. For example, the first server 150 can apply the image processing module 592 to convert a first check image into a second check image. For instance, the first server can convert a color image of the check into a bitonal black-and-white image of the check. A pairing 608 of the color image and the black-and-white image can be stored by the server 150. The bitonal black-and-white image may be stored as a TIFF file. Furthermore, the first server 150 can apply the check analysis module 596. In some embodiments, the check analysis module 596 comprises one or more of the fraud detection instructions 159 and the document analysis and comparison models 157. Depending on the type of request received by the first server 150, the operations of the check analysis module 596 may vary. For example, if the first server 150 receives instructions to register a check, applying the check analysis module 596 may include one or more verifying that the extracted data 606 matches data in the image data 604 and generating a validation object, example aspects of which are described in connection with the operations 704-706 of FIG. 7. As another example, if the first server 150 receives a request to deposit a check, or to validate a check, the check analysis module 596 may perform a fraud detection process, which may include comparing the image data 604 and the extracted data 606 to a stored validation object, which may include a previous image of the check and previously extracted data associated with the check. Example aspects of a fraud detection process for responding to a check deposit request or a check validation request are further described in connection with FIGS. 7 and 9. The server 150 can store an output 610 of the check analysis module 596. For example, if the check analysis module 596 performs a fraud detection process, then the check analysis module 596 can store results of a validation against the validation object. The check analysis module 596 can generate an output 610, which can include results of an analysis.

Additional features of processing a check image using one or more of the check utilities 590 are described in U.S. patent application Ser. No. 18/466,347, filed Sep. 13, 2023, which is hereby incorporated by reference in its entirety. Further, in an example, the OCR implementation includes one or more aspects of U.S. Patent Pub. No. 2022/0319216, which was filed as U.S. patent application Ser. No. 17/569,121 on Jan. 5, 2022, and which is hereby incorporated herein by reference in its entirety for any and all purposes. Further still, additional features of check processing can include fraud detection. In some examples, the fraud detection can include one or more steps or operations described in U.S. patent application Ser. No. 18/052,081, filed Nov. 2, 2022, which is hereby incorporated herein by reference in its entirety for any and all purposes.

FIGS. 7-11 illustrate example methods that may be performed by a combination of one or more of the issuer 12, the issuer device 100, the recipient 14, the recipient device 120, the server 150, and the server 160. FIG. 7 illustrates an example method 700 including registering and validating a check. The method 700 can begin with the operation 702.

Operation 702 includes making a check. For example, the check issuer 12 writes check information on a check. The check issuer 12 writes an amount, including in number form (e.g., “$14.00”) and in word form (“fourteen dollars and 00/100”). The check issuer 12 writes a check recipient identity, such as a name of the check recipient. The check issuer 12 signs the check. The check issuer 12 may further date the check and add a memo. The check may include codes printed thereon. But in some embodiments, the check does not include any codes printed thereon.

Operation 704 includes registering the check. For example, the check issuer 12 may send an image of the check and check information to the server 150 to register the check. An example method for registering the check is described in connection with the operations 402-416 of FIG. 4.

Following registration of the check, the method 700 can move to the operation 706, during which the server 150 may store a validation object, example aspects of which are described in connection with the operations 420-426 of FIG. 4.

Operation 708 includes providing the check from the check issuer 12 to the check recipient 14. For example, the check issuer 12 may mail or physically hand the check to the check recipient 14. Furthermore, the check issuer 12 may provide the check to an intermediate party, which provides the check to the check recipient. Following operation 708, the check recipient receives the check, as shown by the operation 710.

Operation 712 includes negotiating (e.g., depositing) the check. For example, the check recipient 14 can use the recipient device 120 to perform mobile deposit of the check. The recipient 120 device may launch an application, such as a banking mobile application, that is configured to perform mobile deposit. In other examples, the recipient 120 is a teller that performs a deposit using a banking device. The recipient device 120 may capture an image of the check. Furthermore, the recipient device 120 may perform OCR on the check to extract check information. Furthermore, the recipient device 120 may receive an input from the check recipient of check information. The recipient device 120 can provide the check negotiation data to a server. The check negotiation data can include one or more of an image of the check, a check amount, a recipient identity, a routing number, an account number, a date, a memo, a signature, bank information, or other information that is printed or written on the check. Furthermore, the check negotiation data can include information about the negotiation action, such as a negotiation type (e.g., deposit or cashing), a time at which the deposit is initiated or a place from which the negotiation is initiated.

In some embodiments, the check recipient 14 can negotiate the check without using the recipient device 120. For example, the check recipient can deposit the check using an ATM or by bringing the check to a bank.

Operation 713 includes providing the check deposit data to a server. In some instances, the recipient device 120 provides the deposit data to the first server 150. For example, if the application used to deposit the check is provided by the same entity that provides the first server 150, then the recipient device 120 can provide the deposit data to the first server. Such a situation may occur, for example, if the issuer 12 and the recipient 14 are customers of the same bank. In some instances, however, the recipient device 120 provides the check deposit data to the server 160. For example, the recipient 14 may be a customer of a different bank than the issuer 12. The server 160 can receive the check deposit data and route the check deposit data to the server 150 for settlement. Additionally, the server 160 may augment or modify the check deposit data that is sent to the server 150. For example, the server 160 may convert the check image from a full color image to a bitonal black-and-white image. Additionally, the server 160 can confirm, by performing OCR on the check, that the check deposit data received from the recipient device 120 matches the data on the check.

Operation 714 includes receiving the check negotiation data. For example, the server 150 receives the check deposit data from the recipient device 120 or the server 160. In some embodiments, the server 150 augments the received check deposit data. For instance, in an example implementation, the check deposit data may only include an image of the check. In such embodiments, the server 150 can perform image processing on the check to extract additional check deposit data, such as the amount and check recipient identity. Additionally, the server 150 may also perform a verification that any received check deposit data matches the data on the check extracted by performing image processing. In some embodiments, such as when the physical instrument is not a check, the server 150, rather than receiving check deposit data, may receive verification data from the recipient device 120 that includes information pertaining to the instrument. The verification image may include an image of the physical instrument captured by the recipient device 120 and other information that is printed or written on the physical instrument.

Operation 716 includes applying a fraud detection process. For example, the server 150 analyzes the check deposit data for fraud. To do so, the server 150 validates the check deposit data against a validation object associated with the check that is being negotiated. An example method for applying a fraud detection process is described in connection with FIG. 9.

Operation 718 includes determining whether fraud is detected. In response to detecting fraud, the flow of the method can move to operation 720. If fraud is not detected, the flow of the method can move to operation 726.

Operation 720 includes voiding the check. For example, the server 150 can, following positively detecting fraud, void the check that the recipient 14 is attempting to negotiate. By voiding the check, the check may not be subsequently deposited or otherwise negotiated. Voiding the check can include updating a record associated with an account of the issuer 12, such as by changing a status of the check from pending to void or changing a balance of an account of the issuer 12. Changing the balance of the account can include changing the balance to an amount as if the check had not been written.

Operation 722 includes sending an alert. For example, the server 150 can send an alert to the issuer device 100. In some embodiments, the server 150 transmits a push notification to a mobile application on the issuer device 100 that is automatically displayed on a home screen of the issuer device 100. In some embodiments, the server sends instructions to the mobile application to display an alert within a user interface of the mobile application. The alert can indicate to the issuer 12 that a potentially fraudulent deposit attempt was made, and the alert can include information pertaining to the deposit attempt. For example, the alert can include information about the check. Such information can include data stored as part of a validation object that was stored when the check was registered. Furthermore, the check information in the alert can include data pertaining to the deposit attempt, such as the check deposit data received by the server 150. Additionally, the alert can include information from the fraud detection process. Such information can include a reason for which the deposit attempt failed the fraud detection process or a result of one or more fraud detection operations that are further described in connection with FIG. 9.

Operation 724 includes receiving the alert. For example, issuer device 100 can receive the alert from the server 150. Additionally, the issuer device 100 may automatically display the alert via a user interface. In some embodiments, the issuer device 100 includes interactive user interface elements for the issuer 12 to view data associated with the alert. For example, the issuer device 100 may display, in response to a selection of a user interface element, an image of the check when it is was registered by the issuer 12 and an image of the check when it was attempted to be negotiated by the recipient 14 (e.g., deposited or cashed).

While operations 722 and 724 are described above in the context of fraud being detected or the check being invalid, alerts can be sent and received in other contexts. For instance, the sending and receipt of the alert can be performed as a matter of course following the receipt of the data by the server 150 in operation 714. This can advantageously provide additional information to the issuer 12 regarding the processing of the check that was not available before. Further, the alert received by the issuer 12 in operation 724 can further permit the issuer 12 to optionally accept, reject, modify, or otherwise provide additional information to the server regarding the check being processed. Such information can be used as part of the fraud detection or validation processes (operations 716 and 726).

If fraud is not detected at operation 718, the method 700 can flow to the operation 726, which includes determining whether the check is valid. For example, in addition to performing a fraud detection process, the server 150 may perform additional operations to determine whether the deposit attempt is valid. For example, the server 150 can confirm that the check is still pending. In other words, the server 150 can determine that the check has not already been settled or previously voided. As another example, the server 150 can determine whether there are sufficient funds in the an account of the check issue.

Responsive to determining that the check is not valid, the flow of the method 700 can move to the operation 722. For example, as described above, the server 150 can send an alert to the issuer device 100 that a deposit of the check was attempted but failed. Responsive to determining that the check is valid, the flow of the method 700 can move to the operation 730.

Operation 730 includes approving settlement. For example, in response to determining that the check deposit data is not fraudulent and that the check is valid, the server 150 can approve the deposit attempt and process the check deposit data for settlement. Furthermore, the server 150 can modify account data for the issuer 12 to reflect that the check is settled. This can include changing a status of the check from pending to settled and may include updating a balance of the account. For example, the server 150 can change a balance of the account from being pending to being settled. Additionally, the server 150 can send a payment to the recipient 14. If the server 150 has access to an account of the recipient, sending the payment may include transferring money into the account of the recipient. In some instances, however, the sending the payment can include sending money to the server 160, which provides the payment to recipient 14.

Operation 732 includes receiving payment. For example, the recipient 14 can receive payment for the negotiated check from the server 150 or from the server 160

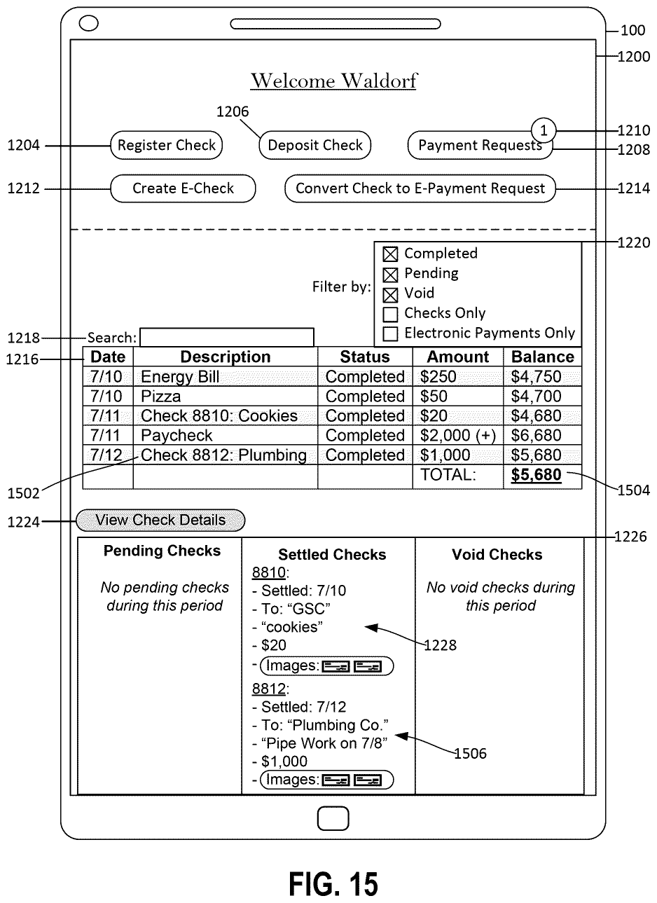

Operation 734 includes receiving an account update. For example, the issuer device 100 can receive data form the server 150 indicating that the check was successfully negotiated (e.g., deposited) and has been settled. The account update may be displayed on a user interface of the mobile device. Furthermore, transactions associated with an account of the issuer 12 can be updated to reflect settlement of the check. This update can include changing how an account balance is displayed from a first user interface style to a second user interface style. In some instances, however, the account update may not change the value of the account balance, because when the check was pending, it may have been presented as if the money associated with the account had been taken out, and when the check is settled, this settlement can represent a confirmation that the money has been taken out. An example of displaying the account update is illustrated in connection with FIG. 15.

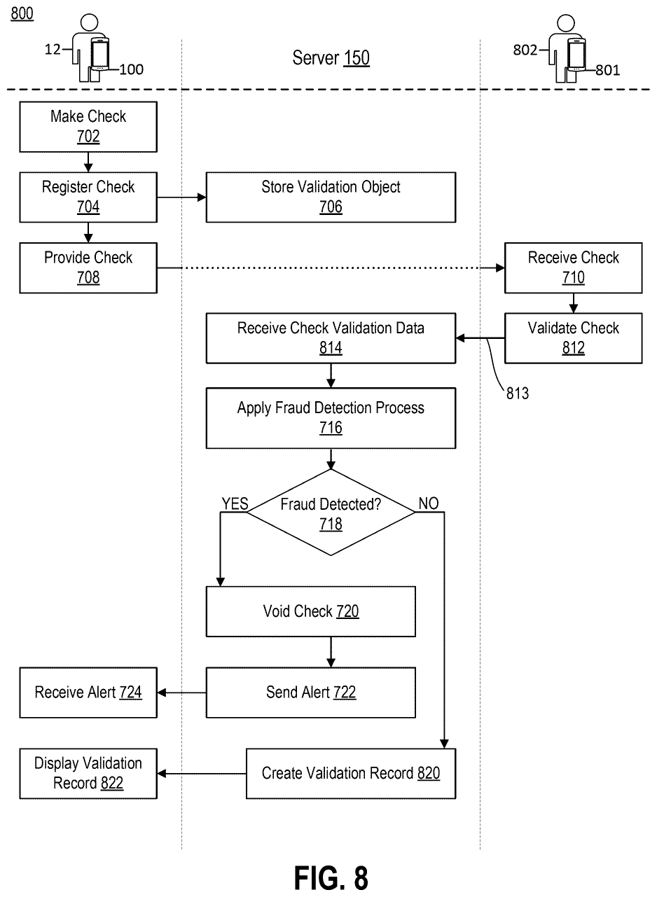

FIG. 8 illustrates an example method for validating a check as part of a chain of custody of the check. In the example of FIG. 8, the holder 802 receives the check from the issuer 12. The holder 802 and the holder device 801 may be the recipient 14 and the recipient device 120, respectively, or may be a later holder in due course of the check. In the example of FIG. 8, the holder 802 is not the check recipient written on the check. For example, the holder 802 is not the final intended recipient of the check and instead is an intermediary between the issuer 12 and the final recipient. Or the holder may be a party holding the check after the recipient on the check has negotiated the check (e.g., with their bank).

The holder 802 can validate the check and generate a validation record to be stored in connection with the validation object of the check. By doing so, an audit trail can be created and stored by the server 150 that tracks locations and information of the check as it passes from one entity to the next. Moreover, although only a single holder 802 is shown in the example of FIG. 8, there may be multiple intermediate holders that successively receive and validate the check prior to the check being provided to the final holder (e.g., the bank of the issuer of the check).

Advantageously, by enabling intermediate users to validate the check, even if they are not depositing the check, a digital trail of the check is created. For example, because an image of the check can be captured with each validation, the physical state of the check can be tracked as it is passes from one entity to the next. As a result, if fraudulent activity is detected, or if a check settlement is contested, the images of the check can be reviewed, either by a human or a computer vision process, to determine where in the chain of custody the check was altered and how the check was altered, even if the fraud was performed by the issuer 12. For example, in certain previous systems, a check issuer may have provided a check to an intermediate party, who provided the check to a final holder. The check negotiated (e.g., deposited) by the final holder may not match the check that was provided by the check issuer to the intermediate party. However, in certain previous systems, it may not have been possible to determine whether the intermediate party or the final check holder modified the check. Such ambiguity may encourage attempted fraud. But with the system disclosed herein, such as in FIG. 8, if a check is altered, it is possible with at least images of the check at different points, to determine when, and who, modified the check, thereby discouraging and ultimately reducing fraud.

The method 800 can begin with the operation 702. Example aspects of the operations 702-710 are described above in connection with FIG. 7. Following receipt of the check by the holder 802, the method 800 can move to the operation 812.

Operation 812 includes validating the check. For example, the holder device 801 may include an option to validate a check. This option may be distinct from an option to deposit a check. The result of validating the check can be the creation of a validation record and a confirmation that the check is not fraudulently altered, but the check is not settled and the holder 802 does not receive payment. Nevertheless, the check validation data collected and generated by the holder device 801 can include some of the same types of information collected and generated when depositing a check, which is described in connection with operation 712 of FIG. 7. For example, the holder device 801 can capture one or more images of the check, and one or more of the check recipient identity written on the check, the amount, and other information written or printed on the check can be automatically extracted by the holder device 801 based on the image of the check or input by the holder 802 into the holder device 801

In some examples, the validation includes not only validating information on a front of the check but also information on the back, such as endorser information. The holder 802 may be different from the recipient 14. For example, the recipient 14 (or another prior holder-in-due-course) may have endorsed the check in an endorsement field (typically on the back of the check) when negotiating the check with the current holder 800. The validation may include, for example, validating that the endorsement is present. In some examples, at the time of endorsement, a prior holder of the check may take an image for processing that results in a validation record. The current check can be compared against a most-recent or other prior validation records.

Operation 813 includes providing the check validation data to the server 150. As described in connection with the operation 713 of FIG. 7, the check validation data may be provided from the recipient device 120 to the server 150 or may be provided from the holder device 801 to the server 160, which provides the data to the server 150.

Operation 814 includes receiving the check validation data. For example, the server 150 can receive the check validation data from the holder device 801 or the server 160. Following receipt of the check validation data, the server 150 can determine whether the check validation data is fraudulent. For example, even though the holder 802 is not necessarily attempting to deposit the check in the same way that the original recipient would, the holder 802 may still have fraudulently modified the check, or the check may have been fraudulently modified before the holder 802 received the check. Therefore, as part of generating a validation record, the server 150 can determine whether there is fraud. To do so, the server 150 can compare the check validation data against the data validation object associated with the check, example aspects of which are described in connection with operations 716-718 of FIG. 7 and FIG. 9. If fraud is detected, the server 150 may void the check and send an alert to the issuer device 100, as described in connection with the operations 718-724 of FIG. 7. Additionally, in the example of FIG. 8, the server 150 may also send an alert to the holder device 801 indicating to the holder 802 that the check has been fraudulently altered. That way, the holder 802 may know, in some instances, that a check received from the issuer 12 has been fraudulently altered. Moreover, the holder 802 may receive, as part of the alert, instructions from the server 150 to not pass along the check to a subsequent party.

If fraud is not detected, the method 800 can move to the operation 820. Operation 820 includes creating a validation record. The validation record can include the check validation data received by the server 150 from the holder 802. Additionally, the validation record can include results from the fraud detection process. The validation record can be stored in association with the validation object generated for the check.

Operation 822 includes displaying the validation record. For example, the issuer device 100 can receive the validation record from the server 150 and display data of the validation record in a user interface. As a result, the issuer 12 is notified that the check was successfully validated by the holder 802 and that a validation record has been stored. Further, the issuer 12 can view the validation data sent by the holder device 801 and compare that data to the validation object and other previous validation records.

As discussed above in relation to FIG. 7, the issuer 12 of the check may receive alerts at various stages of the process even outside of fraud being detected. Further, the alerts may be interactable such that the issuer 12 may provide information or actions that affect how the check is processed (e.g., to facilitate fraud detection).

FIG. 9 illustrates an example fraud detection method 900. The method 900 may be performed after receiving check deposit data, as described for example in connection with the operation 714 of FIG. 7. Additionally, as described in FIG. 8, the fraud detection process described in FIG. 9 may also be applied to check validation data. Moreover, the method 900 can be applied to determine whether non-check physical instruments have been modified. For example, the operation 912 may specifically be applied to determine whether a first, registered visual appearance of the document is in accordance with a second, presented visual appearance of the document. However, in the example of FIG. 9, the fraud detection process is described in context of analyzing an attempted check deposit for fraud. The method 900 can begin at the operation 902.

Operation 902 includes determining an identifier associated with the check deposit data. For example, the server 150 may continually receive requests from different check recipients to deposit different checks written by different issuers. For a given check deposit request, the server 150 may be required to determine a check issuer and a specific check associated with the requests. In some instances, one or more of an issuer account number or a check number is directly received from the server 160 or from the recipient device 120. For example, the issuer account number or check number may be printed on the check. In some instances, however, such as when the check does not include an account number of the issuer 12 on the check, as described in connection with FIG. 2, the server 150 may have to determine the identifier associated with the check deposit data in another manner. As one example, the server 150 may analyze an image of the check in the check deposit data. As part of doing so, the server 150 may decode a 2D code printed on the check to determine the identifier. For example, the server 150 may identify and decode one or more of the 2D codes printed on the check described in FIG. 2 to determine the identifier, or combination of identifiers, that uniquely identifies the check that is being negotiated (e.g., deposited).

Operation 904 includes retrieving a validation object corresponding to the check. For example, the server 150 can use the identifier of the check to lookup a validation object that was stored for the check when the check was registered. The server 150 may then retrieve the data of the validation object that is used for fraud detection, such as, for example, an image of the check, an amount, a check recipient identity, and a check status.

Operation 906 includes comparing the check deposit data against the validation object. For example, the server 150 may perform one or more comparisons of the check deposit data against the validation object data. Examples of such comparisons include the operations 908-912. However, the comparisons need not include each of the operations 908-912, and there may be additional data that is compared between the check deposit data and the validation object. In some embodiments, the operations 908-912 are performed in parallel. In some embodiments, however, the operations 908-912 are performed sequentially, such that if a first comparison fails, then a second, subsequent comparison will not be performed, a feature that can save computing resources by back-loading operations that are relatively computationally expensive, such as image comparison, and only performing such operations if previous operations were successful.

Operation 908 includes comparing a first amount and a second amount. For example, the server 150 can compare a check amount stored in the validation object with a check amount in the check deposit data. If the amounts are in accordance, then the fraud detection process passes the operation 908. If not, the fraud detection fails the operation 908. In some embodiments, the first amount and the second amount must exactly match for them to be in accordance.

Operation 910 includes comparing a first check payee identity and a second check payee identity. In many examples, the payee is the recipient, but in some examples, the comparison may be against a person to whom the check has been endorsed. In an example, the sever 150 can compare a check payee corresponding to the validation object with a check amount corresponding to the check deposit data. If the check payee identities are in accordance, then the fraud detection process passes the operation 910. If not, the fraud detection fails the operation 910. Determining whether the check payee identities are in accordance can depend on the embodiment and specifically may depend on the form of the check payee identities. For example, if the check payee identities are alphabetic strings, then the check recipients may be in accordance if the names refer to the same person. In some embodiments, this requires that each letter of the check recipient identity in the validation object and the check deposit data match. In some embodiments, however, the names may be in accordance if they are sufficiently similar, such that it is determined that the names refer to the same person. As an example, the check recipient identity in validation object may include a middle initial or suffix, whereas the check recipient identity in the check deposit data may not include the middle initial or suffix, yet they can be determined to be in accordance. In some embodiments, such as when the check recipient identity is represented as a numeric or alphanumeric string, then an exact match of the recipient identities in the validation object and the check deposit data may be required.

Operation 912 includes comparing a first visual appearance of the check with a second visual appearance of the check. For example, the sever 150 can compare a check image corresponding to the validation object with a check image corresponding to the check deposit data. If the check images are in accordance, then the fraud detection process passes the operation 912. If not, the fraud detection fails the operation 912. Determining whether the images are in accordance includes determining whether the images are sufficiently similar. For example, a threshold similarity can be pre-defined, and if the similarity between the first and second image is greater than the threshold similarity, then it can be determined that the images are in accordance. However, in some embodiments, generating a similarity score comprises accounting for different types of images. For example, whereas an image of the validation object may be a full color image, the image of the check deposit data may be a black-and-white image.

In some embodiments, determining whether the images are in accordance comprises applying a trained machine learning model to the images. In some embodiments, this includes generating embeddings for the images and determining a similarity of the embeddings. As an example, the server 150 can apply a Siamese network, or a variant thereof, to determine whether the images are sufficiently similar. In some embodiments, the machine learning model implements a pre-trained image processing network that is specifically fine-tuned to determine similarities between (i) a high-resolution color image of a check and (ii) a bitonal black-and-white image of the check. For example, because such images are, due to the color differences, distinct from one another, certain machine learning models that are not fine-tuned to determine whether such pairs of images depict the same object may be deficient. For example, due to color difference, such models may incorrectly determine that these images do not depict the same check, leading to a high false negative rate and over-identification of fraudulent check modification. However, by fine-tuning the machine learning model for the specific task of determining object similarity in a color image and a black-and-white image, the false negative rate is reduced and a detection of fraudulent modification is more likely to correspond with an actual fraudulent check modification.

In an example, the machine learning model may be trained using a plurality of training samples. Each training sample can include a color image of a check, a black-and-white image a check, and a label. The label is positive if the images depict the same check, and that check has not been modified in a fraudulent manner. The label is negative if the images do not depict the same check, or if the images depict the same check, but the check has been modified in a fraudulent manner, such as by changing one or more of the following information on the check: an issuer identity, a recipient identity, the amount, the date, an account number, a memo, or other information that indicates fraud. As one example training technique, contrastive learning may be applied such that (i) embeddings generated for pairs of check images without fraudulent modification are learned to be closer together in a latent space and (ii) embeddings generated for pairs of check images with fraudulent modification are learned to be further from one another in a latent space.

In some embodiments, the machine learning model may be trained to analyze specific fields or areas of the check images to identify fraud, as opposed to analyzing the full images of the checks. This may include applying an ensemble of machine learning models, each of which are fine-tuned to (i) identify an area of interest on the check images and (ii) compare the respective areas of interest to one another to assess similarity. The areas of interest may include, for example, the amount or the recipient identity. In some embodiments, such machine learning models may be trained using supervised learning techniques described above.

In some embodiments, the operation 912 outputs a likelihood that the first visual appearance and the second visual appearance are in accordance. This likelihood may be derived from how close generated embeddings for the first visual appearance and the second visual appearance are to one another. The likelihood may also correspond to how similar areas of interest are to one another.

Operation 914 includes determining whether the check deposit data is valid. For example, the server 150 may determine whether each operation performed during the operation 906 was successful. If so, the server 150 can determine that the check deposit data is valid. In some embodiments, if any of the operations performed during the operation 906 failed, then the server 150 determines that the check deposit data is not valid.

In response to determining that the check deposit data is valid, the flow of the method 900 can move to the operation 730 and may approve settlement of the check deposit data, as described in connection with FIG. 7. In response to determining that the check deposit data is not valid, the method 900 can move to operation 916.

Operation 916 includes sending check deposit data to the issuer device 100. For example, the server 150 can alert the issuer device 100 that a check deposit request was made, but it was determined that the check deposit was not valid due to, for example, failing one or more of the operations 908-912. By doing so, the issuer 12 has the opportunity to override the server 150's determination that the check deposit data was fraudulent or to confirm the server 150's determination that the check deposit data was fraudulent. Beyond that instance, alerts or other notifications may be sent in contexts other than fraud or invalid data being detected.

Alerts may be provided to the issuer 12 (and/or prior holders) to inform them of the status of processing and give them the opportunity to provide information useful in the process (e.g., in validating or detecting fraud).

Operation 918 includes receiving check deposit data. For example, the issuer device 100 can receive, from the server 150, the check deposit data and may be prompted to review the check deposit data for fraud.

Operation 920 includes displaying the check deposit data. For example, the issuer device 100 can display the check deposit data, such as one or more of the recipient identity, amount, or image of the check of the check deposit data. Furthermore, the issuer device 100 can display data of the validation object against which the check deposit data was compared.

Additionally, the issuer device 100 can highlight, specifically, what data in the check deposit data was flagged during the operation 906 as being fraudulently altered. Furthermore, the issuer device 100 can display a side-by-side comparison of the check deposit data that was potentially fraudulently altered with corresponding data of the validation object. For example, if the amount was potentially fraudulently altered, the issuer device 100 may display the amount of the check deposit data and the amount of the validation object, including, in some embodiments, images of the amounts. This side-by-side comparison is particularly advantageous for computing devices with small screens, as it allows a user, with minimal interaction with sometimes constrained navigation options in a mobile application, to have a display of the specific data identified by the server 150 as potentially fraudulent. Additionally, the issuer device 100 can display a likelihood generated by the server 150 that the check was fraudulently altered, which can be based at least in part on results of the operation 912.

Following operation 920, the issuer device 100 can receive an input approving the check deposit data or an input denying the check deposit data, and the method 900 can move to the operation 924 or 926, respectively.

Operation 924 includes receiving an input approving the check deposit data. For example, the issuer device 100 can receive an input from the issuer 12 indicating that the check deposit data is not, in fact, fraudulent. In other words, the issuer 12 can, in some embodiments, override a determination at the server 150 that the check deposit data is fraudulent. As an example, the server 150 may have determined, based on a comparison of the check image in the check deposit data and a check image of the validation object, that the check was fraudulently altered. At the operation 920, the issuer device 100 can display the two images. Based on a review of the two images, the issuer 12 can determine that the check was not actually fraudulently altered and that the server 150's identification of fraud was mistaken or that, if the check was altered, it was not fraudulent and may not have an effect on how the check would be settled. Following operation 924, the issuer device 100 can provide a check approval to the server 150, which can be followed by settlement of the check at operation 730.

Operation 926 includes receiving an input denying the check deposit data. For example, the issuer 12 may confirm the server's identification of the check deposit data being fraudulent. Following operation 926, the issuer device 100 can provide a check denial to the server 150, which can be followed by voiding of the check at the operation 720, as described in connection with FIG. 7.

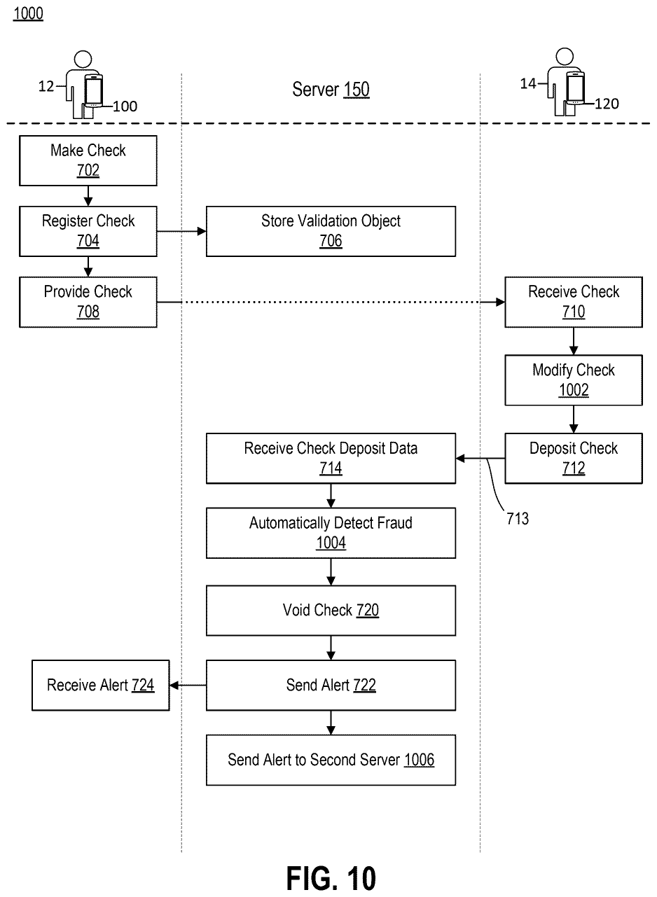

FIG. 10 illustrates an example method 1000 for automatically detecting and rejecting a fraudulently modified check. In the example of FIG. 10, the recipient 14 receives the check from the issuer 12 (e.g., directly or by intercepting the check that was bound for another recipient), fraudulently modifies the check, and attempts to deposit the fraudulently modified check.

Furthermore, in the example of FIG. 10, the server 150 automatically detects the fraud and in response, voids the check.

The method 1000 can begin with the operation 702. Example aspects of the operations 702-710 are described above in connection with FIG. 7. Following receipt of the check by the recipient 14, the method 1000 can move to the operation 1002.

Operation 1002 includes modifying the check. There can be various forms of fraudulently modifying the check. For example, the recipient may 14 write on the check in a way that modifies existing data in one or more fields. The recipient can add letters or numbers to the check, thereby changing one or more of the recipient name, the amount, an account number, a routing number, a date, a memo, a signature, or other information on the check. For example, if the check amount is “1,000”, the recipient 14 can add a “2” to change “1,000” to “21,000”. As another example, the fraudster may attempt to modify a check or account number of the check by writing on the check. As another example, the recipient can erase data on the check (e.g., by “washing” the check to remove at least some ink on the check). In some embodiments, the recipient 14 can use the recipient device 120 or another machine to modify the check. For instance, a recipient may take a photo of the check, manipulate the image (e.g., using image editing software like PHOTOSHOP or by having a generative artificial intelligence produce a new or modified check image), print the manipulated image, and then photograph the manipulated image using a mobile check deposit feature of a banking application.

Following operation 1002, the method 1000 can move to the operations 712-714, example aspects of which are described in connection with FIG. 7. Following the operation 714, the method 1000 can move to the operation 1004.

Operation 1004 includes automatically detecting fraud. For example, the server 150 can apply a fraud detection process described in connection with FIGS. 7 and 9 on the check deposit to determine whether the check deposit data is fraudulent. Specifically, the server 150 can apply the operations 902-914 described in connection with FIG. 9. Advantageously, the server 150 can automatically detect the fraud and then void the check. For example, in some embodiments, rather than prompting the issuer device 100 to confirm or deny the identification of fraud, example aspects of which are described in connection with the operations 916-926 of FIG. 9, the server 150 can void the check without waiting for user approval. The resultant speed of such automatic identification can help with identifying the fraudster and promptly taking remedial action.

Following operation 1004, the method 1000 can move to the operation 720 and automatically void the check. Example aspects of the operations 720-724 are described in connection with FIG. 7. After the check is voided, the operation 1000 can move to the operation 1006.

The operation 1006 includes sending an alert from the server 150 to the server 160. In some embodiments, the server 150 can send this alert when the first server 150 receives the check deposit data from the server 160, such as when, for example, the recipient 14 is a customer of a different bank from the issuer 12.

The alert may be actionable by the issuer 12 such that the issuer may override the fraud alert or provide additional information.

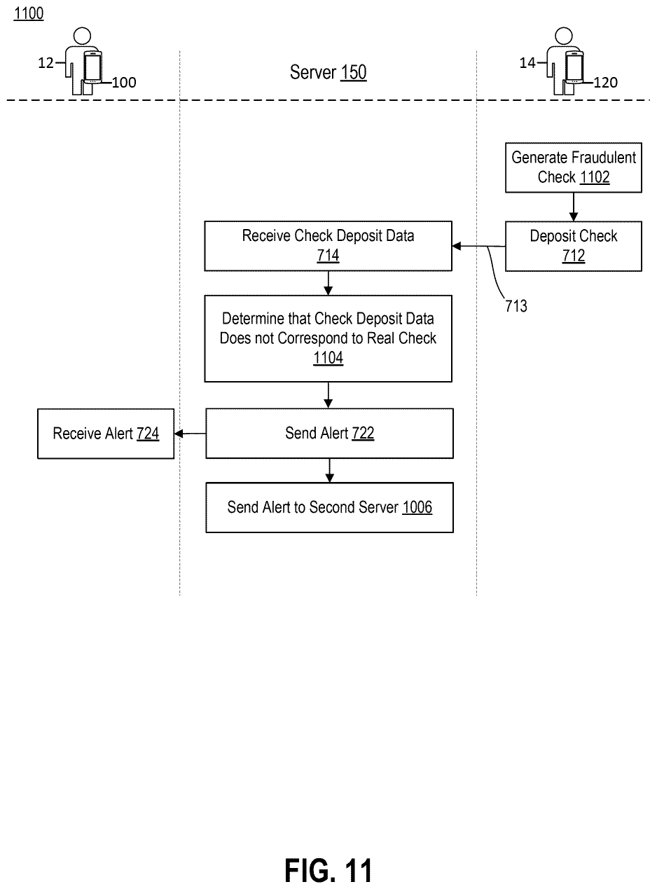

FIG. 11 illustrates an example method 1100 for detecting and rejecting a fraudulent check that is created. In the example of FIG. 11, the issuer 12 has not written nor registered a check. Instead, the method 1100 can begin with the operation 1102.

The operation 1102 includes a “recipient” generating a fraudulent check. For example, the recipient 14 can create a check. In some embodiments, generating the fraudulent check includes using the recipient device 120 or other computers to generate the fraudulent check. This may include using a generative artificial intelligence to create an image that appears to show a valid check having particular information. In some examples, the recipient may intercept a valid check from the issuer 12 and use information obtained from that check to create fraudulent checks, such as by mimicking styles, designs, handwriting, other information, or combinations thereof. In addition or instead, the recipient may use information on the intercepted check to infer additional check numbers of the issuer 12 that exist but have not been written yet. In some examples, the recipient may generate new checks by hand or virtually using image creation software. Information on the check may falsely indicate that it was written by the issuer 12. For example, the check can include one or more of a name or forged signature of the issuer 12. Furthermore, the check can include other information that appears as if the check is a check written by the issuer 12, such as, for example, a check number, an amount, a name, a routing name, and other information. In some embodiments, generating the fraudulent check includes copying parts of an actual check of the issuer. Following the operation 1102, the method 1100 can move to the operation 712. Example aspects of the operations 712-714 are described in connection with FIG. 7. Following the operation 714, the method 1100 can move to the operation 1104.

The operation 1104 includes determining that the check deposit data does not correspond to a real check. For example, the server 150 can perform one or more operations of a fraud detection process, as described in connection with FIG. 9. For example, the server 150 can determine an identifier of the check deposit data, and based on the identifier, lookup a validation object associated with a check that the recipient 14 is trying to deposit. Because the check was fraudulently generated, there is no corresponding validation object for the check. As a result, the server 150, in response to failing to identify a validation object, can automatically reject the check deposit data. In this way, registering checks and using validation objects prevents users from fraudulently creating checks. However, if an issuer 12 is not required to generate a check validation object, then the mere absence of a validation object may be insufficient by itself to determine that the check is invalid. But it may be an indication that it is. The lack of validation objects may prompt the server 150 to contact the issuer 12 to obtain information regarding whether the check is real or fraudulent. In some examples, this 1100 can be expanded to include elements of other methods herein (e.g., method 900) to allow for real time decisioning by the issuer 12).

In some embodiments, the server 150 can determine that the check does not correspond to a real check by performing image analysis on an image of the check in the check deposit data. For example, the server 150 may attempt to identify one or more security features on the check, such as, for example, a digital watermark or one or more 2D codes, as described in connection with FIG. 2. In response to failing to identify the one or more security features or in response to determining that one or more of the security features are incorrect, the server 150 may determine that the check does not correspond to a real check.

Operations 722-724 include sending an alert to the issuer device 100 and receiving the alert by the issuer device 100, as described in connection with FIG. 7. For example, the alert can inform the user that a fraudulent check deposit attempt was made that used at least some information associated with the issuer 12, such as the issuer 12's name or account name, and that the server 150 detected the fraud. Operation 1006 includes sending an alert to the second server 160, as described in connection with FIG. 10.

### Account Balance User Interface

FIGS. 12-17 illustrate an example user interface 1200. The user interface 1200 can be displayed by the issuer device 100. As described in connection with FIGS. 12-17, the user interface 1200 can be part of a mobile application installed on the issuer device 100. The mobile application may be, for example, a banking mobile application. In some embodiments, the user interface 1200 can be rendered within and provided by a web application that is provided from a system associated with the first server 150. For example, the web application can be part of a banking application. In the examples of the FIGS. 12-17, the user interface 1200 comprises an account balance user interface for an example user. Although illustrated in FIGS. 12-17 as a single user interface, components of the user interface 1200 may be part of multiple different user interfaces, or across multiple applications that are communicatively coupled. Moreover, the user interface 1200 can include more or fewer components than described in connection with FIGS. 12-17.

FIG. 12 illustrates an example user interface of a mobile device illustrating an example account state. The user interface 1200 includes three regions. A top region includes options to perform banking actions, a middle region includes an account registry, and a bottom region includes check data.

In the top region, the user interface 1200 includes a register check option 1204, a deposit check option 1206, a payment requests option 1208, a create e-check option 1212, and a convert check to e-payment request option 1214. Each of these options comprises a selectable user interface element, such as a button or other input field. Selection of any of these options may cause the mobile application to begin performing a corresponding process.

Responsive to detecting selection of the register check option 1204, the mobile application can register a check, such as using the process described in association with FIG. 4.

Responsive to detecting selection of the deposit check option 1206, the mobile application can perform mobile deposit of a check.

Responsive to detecting a selection of the payment requests option 1208, the mobile application can display pending payment requests. Thereafter, the issuer 12 can select whether to approve or deny any pending payment requests. The payments requests can be requests sent by the issuer 12 and requests received by the issuer 12. In some instances, a payment request can be received from a recipient 14 who received a physical check written by the issuer 12 and who converted the physical check into a digital payment request. The notification 1210 indicates that the issuer 12 received a digital payment request.

Responsive to detecting selection of the create e-check option 1212, the mobile application can, using further input from the issuer 12, create and send an e-check, a process that is further described in connection with FIGS. 20-22, infra.

The user interface 1200 further includes a transaction table 1216. The transaction table 1216 includes transactions for the issuer 12. In the example shown, the transaction table 1216 includes, for each transaction, a date, description, a status, and amount. Furthermore, the transaction table 1216 includes a cumulative account balance that is updated with each transaction. The transaction table 1216 can include transactions corresponding to checks, electronic payments, bank-to-bank transfers, or other transactions. The transaction table 1216 further includes a balance 1222. The balance 1222 may be the total account balance for the user after account for all transactions in the transaction table 1216. In the example of FIG. 12, the balance 1222 is underlined and bolded.

The user interface 1200 further includes a search field 1218, via which the issuer 12 can input text to search for transactions in the transaction table 1216. Additionally, the user interface 1200 includes filters 1220. The filters 1220 include various filters that the issuer 12 can select to modify which transactions are displayed in the transaction table 1216. For example, the filters 1220 include filtering the transaction table 1216 by completed transactions, pending transactions, void transactions, only checks, and only electronic payments. Other filters, including user-defined custom filters, are also possible.

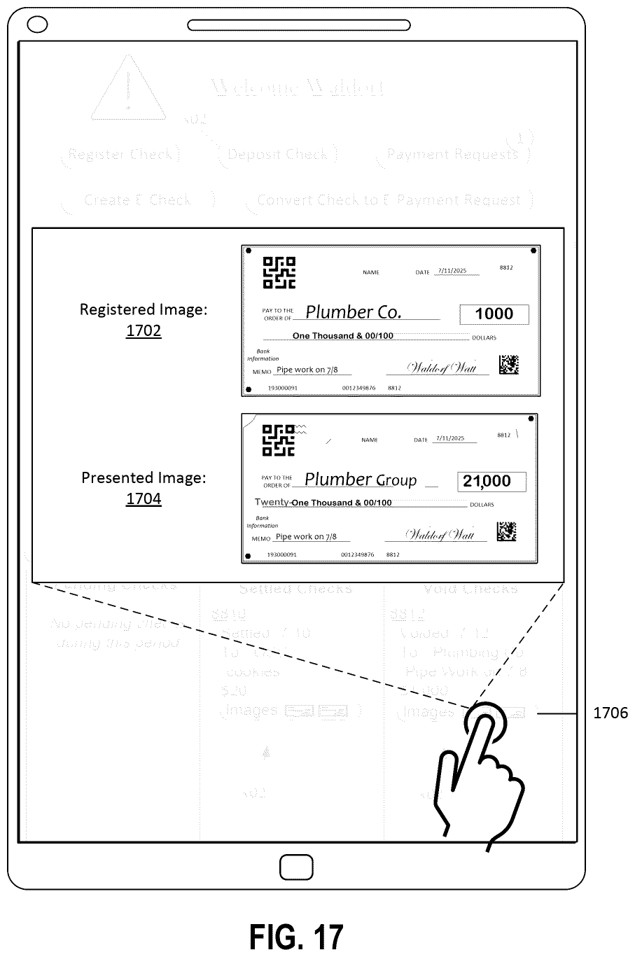

The user interface 1200 further includes a check region 1226. In some embodiments, the check region 1226 is displayed in response to receiving a selection of the view check details option 1224. The check region 1226 displays information about checks issued by the issuer 12. In the example shown, the check region 1226 includes three sections: pending checks, settled checks, and void checks. In some instances, check data in the check region 1226 corresponds to checks in the transaction table 1216. In the example of FIG. 12, there are no checks in the pending checks or void checks sections. The check region 1226 incudes settled check data 1228 in the settled checks section. The settled check data 1228 includes data regarding a settled check. For example, the settled check data 1228 indicates that the settled check has an identifier of “8810,” that it was settled on “July 10,” that the memo line stated “cookies,” and that the amount was $20. In an example, the information from the memo line of the associated check can be determined using an optical character recognition process and be associated with the check during a process described herein. Furthermore, the settled check data 1228 includes images of the check. The images may include one or more of a check image captured when the check was registered, and that was subsequently stored as part of a validation object, and an image of the check when the check was negotiated (e.g., deposited). The negotiated image may be a bitonal black and white image. In the example of FIG. 12, the images are, to accommodate a small screen of the mobile device, shown as reduced-sized thumbnails integrated into a selectable button. In response to receiving a selection of the button, the user interface 1200 can display larger versions of the check images, an example of which is illustrated in FIG. 17.

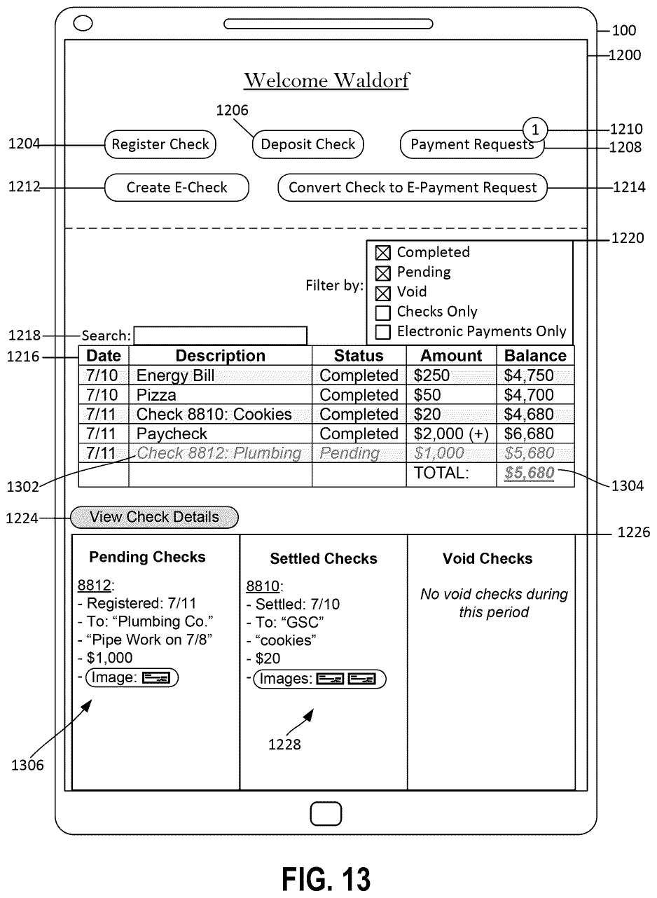

FIG. 13 illustrates the example user interface of FIG. 12 after a pending check is registered. For example, the issuer 12 may register a check according to the method described in connection with FIG. 4. As an example, the issuer 12 may register the check 200 of FIG. 2.

After the check is registered, the mobile application can display the user interface 1200, such as in response to receiving an account balance inquiry from the issuer 12. The transaction table 1216 is updated to include the pending transaction 1302. The pending transaction 1302 includes data corresponding to the check that was registered, including a status indicating that the check is pending, which may indicate that the check was registered but has not yet been negotiated (e.g., deposited). Furthermore, the transaction table 1216 includes an updated account balance 1304. The updated account balance 1304 accounts for the pending transaction 1302. For example, the updated balance 1304 is $1,000 less than the balance 1222 due to the pending transaction 1302. Thus, although the $1,000 corresponding to the check may still technically be in the issuer's account, the updated account balance 1304 is updated as if the money corresponding to the check had already been withdrawn. This ensures that the issuer will not accidentally, or fraudulently, spend the money in the account that is to be used to settle the pending transaction 1302.

Advantageously, the balance 1304 is displayed in a different user interface style than the balance 1222. For example, the balance 1304 is italicized, whereas the balance 1222 is not.

Such a change in the user interface style indicates to the issuer 12 that the displayed balance 1304 reflects a pending transaction. The check region 1226 of the user interface 1200 further includes the pending check data 1306. The pending check data 1306 shows further information of a registered, pending check, including the following: a check number, a date on which the check was registered,” a check recipient identity, a memo, an amount, and a check image.

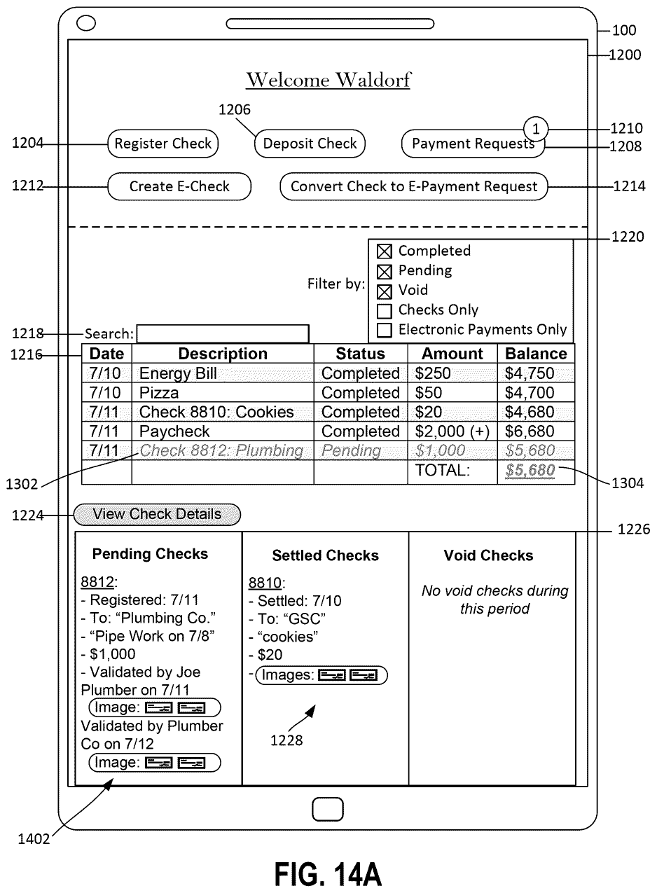

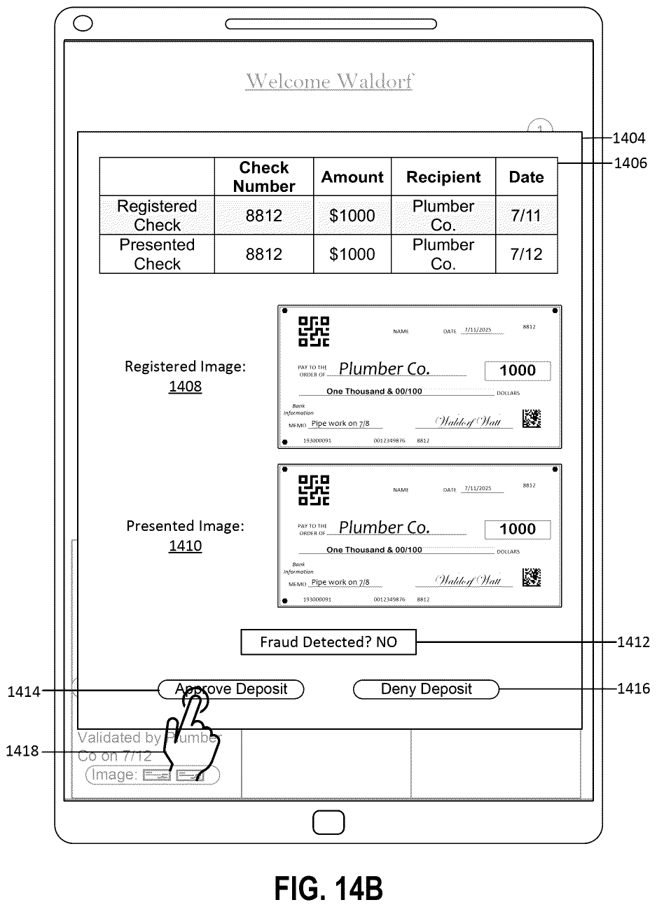

FIG. 14A illustrates the example user interface of FIGS. 12 and 13 showing an audit trail of the pending check prior to deposit and settlement. For example, as described in connection with FIG. 8, the check may be validated by intermediary recipients (e.g., holders-in-due course or other intermediaries). For example, intermediary recipients who possess the check can submit check validation data to the server 150, including a check image, and the server 150 can validate the check validation data against a validation object to verify that the check has not been fraudulently altered. By doing so, the system can create an audit trail, and the information pertaining to such validations can be displayed by the user interface 1200.

In the example of FIG. 14A, the check region 1226 shows the results of validations. For example, the pending check data 1402 shows information corresponding to two validations that were performed associated with the check. For example, the pending check data 1402 shows that a validation was performed for the check 8812 on July 11 by “Joe Plumber”. Furthermore, the pending check data 1402 includes check images associated with the validation performed by Joe Plumber. The images may include the check image when the check was registered, and a color or black-and-white image of the check when it was validated by Joe Plumber. Furthermore, the pending check data 1402 includes data of a second, subsequent validation that was performed by an entity that possessed the check after Joe Plumber. For example, the pending check data 1402 indicates that the check was validated on July 12 by Plumber Co. In some embodiments, the second validation record includes a check image that was captured during validation of the check by Plumber Co and the check image of the validation object when the check was registered.

FIG. 14B illustrates an example user interface 1404 for a check issuer to approve or deny an attempted negotiation of a presented check. In the example of FIG. 14B, the attempted negotiation is an attempted deposit of the check; however, the features for the issuer 12 to approve or deny the presented check described in connection with FIG. 14B are not limited to attempted check deposits. In some embodiments, the user interface 1404 is displayed to the issuer 12 after presentment of the check by the recipient 14, or by another entity that attempts to deposit the check. For example, the server 150 can send an alert to the issuer device 100 in response to receiving an attempted deposit. Upon receiving a selection of the alert, the issuer device 100 may display the user interface 1404. Features of the user interface 1404 enable the issuer 12 to approve or deny the attempted negotiation (e.g., deposit) of the check before the check is settled or voided. In some embodiments, the issuer 12 can approve or deny the attempted deposit, and the server 150 can also perform validation of the check deposit data against the validation object, as describe din connection with FIG. 9, thereby providing multiple layers of security to mitigate fraud. In some embodiments, the issuer 12 can approve or deny the attempted deposit data as illustrated in connection with FIG. 14B without the server 150 separately performing validation steps, or vice-versa. In the example shown, the user interface 1404 includes a table 1406, a registered image 1408, a presented image 1410, a fraud detection flag 1412, an approve deposit option 1414, and a deny deposit option 1416. Example aspects of data that may be displayed in the user interface 1404 are further described in connection with the operations 918-926 of FIG. 9.

The table 1406 includes data of the validation object associated with a registered check and deposit data associated with the presented check. For example, the validation object, which corresponds to the registered check with check number 8812 in the example of FIGS. 12, 13, and 14A, includes a check number, an amount, a recipient, and a date, as shown in the table 1406. Furthermore, the validation object can include the registered image 1408, which can be displayed by the user interface 1404. The table 1406 further comprises check negotiation data, such as check deposit data, example aspects of which are described in connection with the operations 712 and 714 of FIG. 7. For example, for the presented check, the user interface 1404 displays a check number, amount, recipient, and date of the presented check. Furthermore, the user interface 1404 can display a presented image 1410 of the check that was captured, for example, by the recipient device 120.

The fraud detection flag 1412 indicates whether the server 150 detected fraud in the check deposit data. In some embodiments, the fraud detection flag 1412 is a binary value indicating whether fraud was detected. In some embodiments, the fraud detection flag 1412 is a numerical value representing a likelihood of fraud. The value of the fraud detection flag 1412 can depend on an output of a fraud detection process performed by the server 150, such as the operation 906 of FIG. 9. In the example of FIG. 14B, the fraud detection flag 1412 indicates that fraud was not detected. Advantageously, the fraud detection flag 1412 indicates to the issuer 12 the results of the fraud detection process performed by the server 150, thereby informing the issuer 12 whether to approve or deny the presented check, while still keeping the ultimate decision of whether the presented check is approved or denied with the issuer 12. In some embodiments, however, the presented check is automatically approved or denied by the server 150 without requiring further input from the issuer 12.

The approve deposit option 1414 and the deny deposit option 1416 are input fields that may be selected by the issuer 12. For example, the approve deposit option 1414 and deny deposit option 1416 may be buttons. Responsive to receiving a selection of the approve deposit option 1414, as shown, for example, by the selection 1418, the issuer device 100 can notify the server 150 that the check deposit data was approved, and in response, the server 150 may approve settlement of the check, as described, for example, in connection with the operation 730. Responsive to receiving a selection of the deny deposit option 1414, the issuer device 100 can notify the server 150 that the check deposit data was denied, and in response, the server 150 may void the check, as described, for example, in connection with the operation 720.

FIG. 15 illustrates the example user interface of FIG. 12 showing an updated account state after deposit and settlement. For example, the mobile application may display the user interface 1200 after performance of the steps 730 and 734 of FIG. 7. In the example of FIG. 15, the transaction table 1216 includes the transaction 1502, which shows that Check 8812 was successfully settled. For example, the recipient 14 may have deposited the check and one or more of the server 150 and the issuer 12 may have determined that the deposit attempt was not fraudulent. As shown, a user interface style of the balance 1504 is updated to indicate that the balance is no longer pending. For example, compared to the balance 1304, the balance 1504 is no longer italicized. The check region 1226 include the check data 1506, which indicates that the check 8812 has been settled. The check data 1506 includes information corresponding to the settlement of the check, including the following: a settled date, an identity of the check recipient that negotiated the check, a memo, an amount, and one or more images. The images can include the check image associated with registering the check and the check image associated with depositing the check. The check image associated with depositing the check can be a black-and-white image. In the example shown, the images are shown as thumb nails that, when selected, cause larger versions of the check images to be displayed by the user interface 1200.

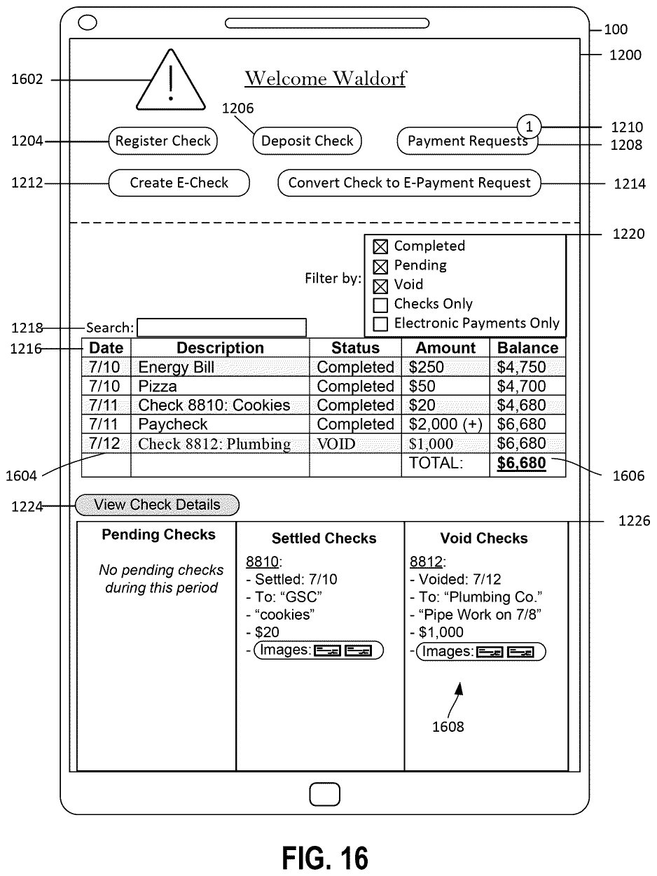

FIG. 16 illustrates the example user interface of FIG. 12 after detection of fraud on the check, for example at a time of validation or deposit. In the example of FIG. 16, the user interface 1200 includes an alert 1602. The alert 1602 indicates to the issuer 12 that there was an attempt to deposit a check of the issuer 12 but that the attempt was flagged as fraudulent. In the example of FIG. 16, the transaction table 1216 includes the transaction 1604, which shows that check 8812 was successfully void. For example, the check may have been fraudulently altered, and in response to an attempted deposit of the fraudulently altered check, the server 150 voided the check, example aspects of which are described in connection with FIGS. 7-9. As shown, a user interface style of the balance 1606 is updated to indicate that the balance is no longer pending. In some embodiments, the user interface style of the balance 1606 shows that a transaction in the transaction table 1216 was voided due to attempted fraud. For example, the balance 1606 may be shown in red.

The check region 1226 include the check data 1608, which indicates that the check 8812 has been voided. The check data 1608 includes information corresponding to the check, including the following: a voided date, an intended recipient identity, a memo, an amount, and one or more images. The images can include the check image associated with registering the check and the check image associated with the attempted fraudulent deposit of the check. The check image associated with depositing the check can be a black-and-white image. In the example shown, the images are shown as thumb nails that, when selected, cause larger versions of the check images to be displayed by the user interface 1200. An example of selecting an input field to view the check images is illustrated in FIG. 17.

FIG. 17 illustrates operation of a user interface by a check issuer to view check images included in an audit record within an account associated with the check issuer. For example, the user interface of FIG. 17 can be displayed following FIG. 16 and a selection 1706 of the check data 1608. In response to receiving the selection 1706, the mobile application displays the check image 1702 and the check image 1704. The check image 1702 corresponds to a check image when the check was registered by the issuer 12. The check image 1704 corresponds to a check image when the check was attempted to be negotiated. In the example shown, the check image 1704 shows that the check was altered, such that the amount and the check recipient identity are not in accordance with the original check image. Accordingly, the issuer 12 can see why the check was flagged as fraudulent and voided.

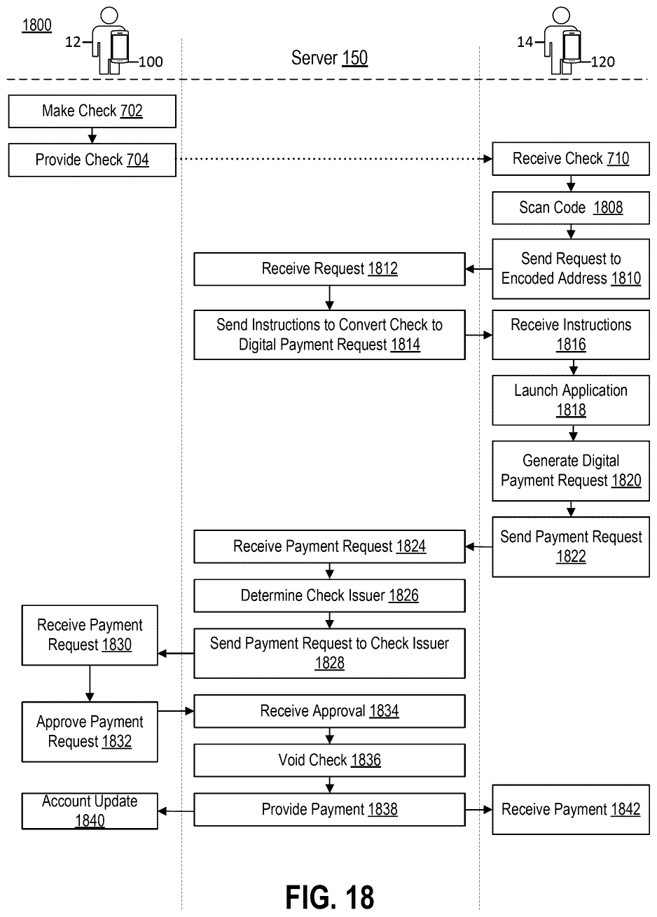

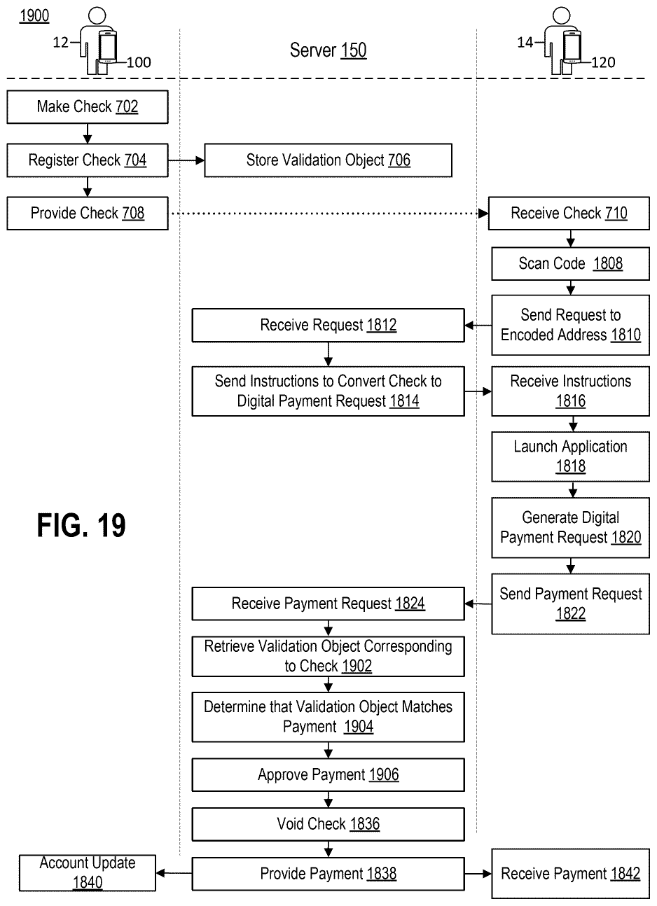

FIGS. 18 and 19 illustrate example methods 1800 and 1900, respectively, for converting a check into electronic payment. In the examples shown, the operations can be performed by one or more of the issuer 12, the issuer device 100, the server 150, the recipient 14, and the recipient device 120. In some embodiments, the interchange server 190 performs operations of the method 1800 and 1900 that are described herein as being performed by the server 150. In the example of FIG. 18, the issuer 12 may not register the check. In the example of FIG. 19, by contrast, the issuer 12 may registered the check, and a corresponding validation object may be created and used to automatically validate and approve a digital payment request.

The method 1800 can begin with the operation 702. Example aspects of the operations 702, 704, and 710 are described in connection with FIG. 7.

The operation 1808 includes scanning a code on the check. For example, the recipient 14 may use the recipient device 120 to scan a 2D code printed on the check. As an example, the recipient device 120 may scan a QR code, such as the first code 208 of FIG. 2. By doing so, the recipient device 120 can decode the 2D code to determine address encoded by the code. The address may be, for example, a URL. For example, the address may be associated with an application of the server 150. In some embodiments, the recipient device 120 can display the address or a name of an application associated therewith, and the recipient 14 can select a link associated with the address. In some embodiments, the 2D code encodes a deep link to a mobile application installed on the recipient device. Furthermore, in response to scanning the 2D code, the recipient device 120 can launch the mobile application if it is installed on the recipient device 120.

Operation 1810 includes sending a request to an address decoded from the code. For example, the recipient device 120 can send a request to retrieve application data from an application associated with the address. For example, the check may be provided by a bank associated with the first server 150. The code on the check may include a web address associated with the first server 150. When a request is sent to that web address, instructions, such as instructions to launch, or otherwise access, a digital payment application, can be sent by a web server associated with the first server to the recipient device 120. For example, the request may correspond to a request for instructions to convert the check into a digital payment request. In some embodiments, the recipient device 120 uses a web browser to send the request to a server, such as server 150. The request may be sent either directly to server 150, or the address may identify an intermediary server (e.g., a web server communicatively connected to server 150). The request may be, for example, an HTTP request. In some embodiments, the request includes an identifier extracted from the code.

Operation 1812 includes receiving the request. For example, the server 150 can receive the request.

Operation 1814 includes sending instructions to convert the check into a digital payment request. For example, in response to receiving the request, the server 150 can transmit instructions for converting the check into a digital payment request to the recipient device 120. In some embodiments, the instructions include data for a web application for converting the check into a digital payment request. In some embodiments, the instructions include a link to a different application for generating a digital payment request.

Operation 1816 includes receiving the instructions from the server 150.

Operation 1818 includes launching an application to generate a digital payment request. Depending on the embodiments and depending on the instructions received from the server 150, a different application may be launched to generate a digital payment request. As one example, launching the application includes using a web browser to execute or access an application sent by the server 150. In some embodiments, launching the application includes launching a mobile application installed on the mobile device or launching an application to download a mobile application. In some embodiments, the application is a third-party payment exchange application that facilitates bank-to-bank transfers for users. Examples of such applications include ZELLE and VENMO. In some embodiments, the application is provided by the server 150. In some embodiments, launching the application 1818 can be performed directly in response to scanning a 2D code on the check, in which case the operations 1810-1816 may be not performed. For example, in response to scanning the 2D code, the recipient device 120 can launch a payment application, such as an application provided by the interchange server 190 or the server 150, to generate a digital payment request.

Operation 1820 includes generating a digital payment request. For example, the recipient device 120 can generate a digital payment request using the application launched during the operation 1818. In some embodiments, generating the digital request includes receiving, at the recipient device 120, manual input of the information on the check, such as, for example, an issuer name, a recipient name, an amount, or other information that is printed or written on the check. In some embodiments, the digital payment request includes an identifier of the issuer 12. The identifier may be, for example, a name or account number of the issuer printed on the check. As another example, the identifier may comprise numbers or letters encoded by one or more 2D codes printed on the check. In some embodiments, the identifier may be transmitted in the request by sending an image of the check that includes the one or more 2D codes, such that the identifier may be extracted from the 2D code by the server 150. In some embodiments, generating the digital request includes capturing, using the recipient device 120 an image of the check. Thereafter, an OCR process can be performed to extract information written or printed on the check to complete a digital payment request.

Operation 1822 includes sending a payment request. For example, the recipient device 120 can send the digital payment request to a server. In some embodiments, the payment request is sent to first server 150. For example, if the application used to generate the digital payment request is provided by the first server 150, then the request may be sent directly to server 150. In some embodiments, the payment request is sent to the second server 160, which may route the request to the first server 150. In some embodiments, the payment request is sent to a server a third-party system, such as the interchange server 190. The interchange server 190 may then route the payment request to the first server 150 based on information in the request, such as a routing number or an identification of a bank of the first server.

Operation 1824 includes receiving the payment request. For example, the server 150 receives the payment request that was sent by the recipient device 120.

Operation 1826 includes determining a check issuer of the check. For example, based on data of the digital payment request, the server 150 determines an account or identity of the issuer 12. In some embodiments, the server 150 processes an image in the digital payment request to extract an identifier in a 2D code printed on the check and using the identifier, looks up an account for the issuer 12. In some embodiments, the identifier is sent as numbers or letters in the payment request, and the server 150 uses the numbers or letters to lookup the check issuer.

Operation 1828 includes sending the payment request to the check issuer 12. For example, the server 150 can send, either via an application provided by the server 150 or an application associated with the interchange server 190, the payment request to the issuer device 100. The payment request can include data received from the recipient device 120.

Operation 1830 includes receiving the payment request. For example, the issuer device 100 can receive the payment request and prompt the issuer 12 to review the payment request. In some embodiments, the issuer device 100 can display the payment request using the same application used by the recipient device 120 to generate the payment request. In some embodiments, the issuer device 100 can display at least some of the data sent from the recipient device 120 as part of the digital payment request. As an example, the issuer device 100 can display one or more of the following: a recipient identity, an amount, a memo, a check number, a time that the request was sent, a location from which the request was sent, an image of the check, or other data printed or written on the check. The issuer device 100 can further prompt the issuer 12 to approve or deny the digital payment request. In some embodiments, if the issuer 12 denies the request, the server 150 alerts the recipient 14 that the request was denied. In response, the recipient 14 may still be able to deposit the check without using a digital payment request.

Operation 1832 includes approving the payment request. For example, the issuer device 100 may receive, from the issuer 12, an approval of the digital payment request and send the approval to server for processing. As shown, the approval may be sent directly to the server 150 or routed to the server 150.

Operation 1834 includes receiving the approval. For example, the server 150 may receive the approval of the digital payment request from the issuer 12.

In some examples, the issuer 12 gives permission to allow (or explicitly disallow) the check to be converted into an alternative form of payment during the registration of the check and the creation of a validation object. If such information is provided at that stage, then operations 1828-1834 can be bypassed.

Operation 1836 includes voiding the check. For example, the server 150 can void the check, such that it cannot be negotiated (e.g., deposited or cashed) at a later time. That is, even though there was no fraud detected, the server 150 can void the physical check, because instead of depositing or otherwise negotiating the check, the check was converted into a digital payment such that the recipient 14 sent a digital payment request that was approved by the issuer 12. Advantageously, voiding the check ensures that the recipient 14, or another party, cannot both submit a digital payment request and successfully deposit the check (amounting to representment fraud). Beneficially, the codes or other indicia on the check may further resist representment fraud by being usable by a counterparty to the negotiation to verify whether the check is still valid.

Operation 1838 includes providing payment. For example, the server 150 can, in response to receiving the approval of the payment request, cause the transfer money from the issuer account to the recipient. This can include modifying an account record of the issuer to reflect that payment. The modification of the account record may further indicate that the check has been voided. Providing payment to the recipient 14 can include authorizing the interchange server 190 or server 160 to provide the payment to the recipient 14.

Operation 1840 includes displaying an account update. For example, a user interface of the issuer device 100 can display a transaction indicating that payment was provided to the recipient 14. Further, the user interface may indicate that the check was voided.

Operation 1842 includes the recipient 14 receiving payment. For example, the recipient 14 can receive payment for the digital payment request. In some embodiments, the recipient 14 can also receive instructions before or after receiving the payment to alter the check such that it cannot be successfully negotiated or at least resist future successful negotiation, such as crossing out data on the check, destroying the check, or otherwise modifying the check. For instance, the recipient may be instructed to endorse the check or in one or more fields of a check (e.g., the check may be printed with a check box that is to be filled in if it is converted to another form of payment). After receiving such instructions, the recipient device 120 can capture an image of the check showing that it is altered in a way that resists representment fraud and send the image to the server 150. In addition to or instead, the check can be printed or otherwise manufactured with one or more elements that can be destroyed to reveal a code necessary for completion of the conversion of the check into an electronic payment. For instance, there may be a code obscured by a scratch-off coating or a feature that must be peeled off or torn to reveal the code. In some examples, the payment may be held until proof of modification is sent to the server and verified.

In an example, before a part of the conversion process (e.g., before the two-dimensional code printed on a check is scanned) the check has a first physical configuration and after another part of the conversion process, (e.g., after the digital payment request is approved), the check is in a second physical configuration that resists representment and resists transformation back into the first physical configuration. The resisting of the transformation back into the first physical configuration can be based on the transformation from the first configuration to the second configuration being destructive (e.g., tearing, scratching, inking, or otherwise physically modifying the check) in a way that is difficult to reverse.

FIG. 19 illustrates an example method 1900 for converting a check into an electronic payment. As described above, in the example of FIG. 19, the issuer 12 can register the check, and the corresponding validation object can be used to automatically validate and approve the digital payment request.

The method 1900 can begin with the operation 702. Example aspects of the operations 702-710 are described in connection with FIG. 7. The method 1900 further includes the recipient 14 generating and sending a digital payment request using the operations 1808-1824, which are further described in connection with FIG. 8.

The operation 1902 includes retrieving a validation object corresponding to the check. For example, the server 150, using one or more identifiers of the issuer 12 and check that may be sent with the digital payment request, may determine whether there is a stored validation object corresponding to the check and, if so, retrieve the validation object.

Operation 1904 includes determining that the validation object matches the digital payment request. For example, the server 150 can compare data received in the digital payment request with the validation object. For example, the server 150 can compare one or more of the respective amounts and check recipient identities of the validation object and the digital payment request and determine whether they are in accordance. If they are in accordance, the server 150 can determine that the validation object matches the digital payment request. In some embodiments, the server 150 may apply operations of a fraud detection process to determine whether the digital payment request matches the validation object, described in connection with the method 900 of FIG. 9.

Operation 1906 includes approving the digital payment request. For example, the server 150, in response to determining that the digital payment request matches the validation object, can automatically approve the digital payment request. For example, as part of registering the check, the issuer 12 can authorize the server 150 to approve a digital payment request that matches the check. Following approval of the payment, the method 1900 can move to the operations 1836-1842, which are described in connection with FIG. 18.

### Electronic Check

In some instances, rather than creating a validation record of a document as described above, in the context of checks, a user may not have convenient access to his or her physical checks. Accordingly, a user may electronically initiate creation of a check, for example from a mobile device. This electronic generation and issuance of a check may be performed in conjunction with the registration, audit, and validation of a check as described above in conjunction with FIGS. 4-17, and/or subsequent conversion to a realtime payments operation as described in conjunction with FIGS. 18 and 19.

FIG. 20 illustrates an example method 2000 for electronically generating and issuing a check. The method 2000 can begin with operation 2002, during which the issuer 12 launches an electronic check application on the issuer device 100.

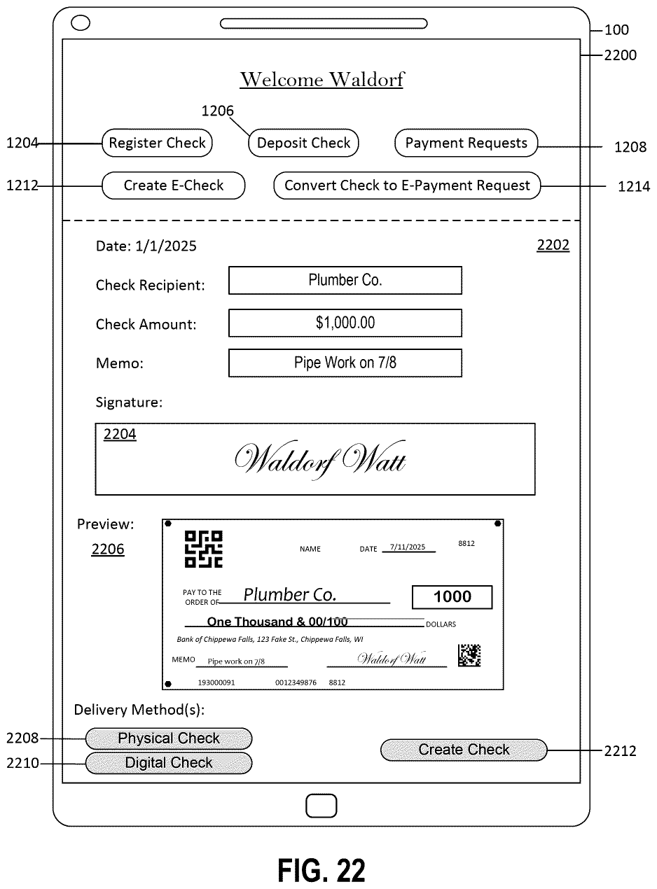

Operation 2004 includes inputting check data. For example, using a user interface of the application, the issuer 12 can input a check recipient identity, such as a payee name, and an amount. The issuer 12 may further input a memo, a date, and other information to be included on the check. An example user interface is illustrated in FIG. 22.

Operation 2006 includes sending a request to generate a digital check using the check data. For example, the issuer device 100 can send the check data to the server 150. Sending the check data may further comprise sending credentials of the issuer 12.

Operation 2008 includes generating a code. For example, the server 150 can generate a 2D code, such as a data matrix or a QR code, to be printed on the check. The 2D code may encode basic information, such as an identification of the issuer 12, an account number, and a check number. Additionally, the 2D code may encode enriched data, such as the payee identity, the amount, the date, and other information input by the issuer 12.

Operation 2009 includes generating a digital check. For example, the server 150 can generate a digital representation of the check that includes the check data input by the issuer 12 and the generated 2D code. The digital representation of the check may take the form of an image-based depiction of a check to be generated in response to the request from the issuer 12. In some examples, this generation automatically includes creation of a check validation object 426.

Operation 2010 includes providing a preview of the digital check. For example, the server 150 can send the digital representation of the check to the issuer device 100.

Operation 2012 includes displaying the digital check. For example, the issuer device 100 can display the preview of the digital check via a user interface.

Operation 2014 includes confirming the digital check. For example, the issuer 12 can review the preview and confirm that the check information is accurate. In some instances, if the check information is not accurate, the issuer 12 may abort creation of the check, or go back (e.g., using the interface of FIG. 22) to update or correct certain check information. As seen in FIG. 22 as a user updates check information, the digital representation of the check may be updated periodically or in realtime in response to user edits.

Operation 2016 includes selecting delivery methods. For example, the issuer 12 can select whether to generate a paper version of the check to be mailed or an electronic version of the check to be electronically delivered to the recipient 14.

Operation 2020 includes sending the check. For example, based on the selected delivery method, the server 150 can initiate delivery of the check.

Operations 2022 and 2024 include delivering the check according to the selected delivery method. For example, if the issuer 12 selected to mail a paper version of the check, then during operation 2022, a paper version of the check can be mailed to the recipient 14. Mailing the paper version of the check to the recipient may be performed by a mailer system communicatively connected to the server 150, for example based on previously stored or issuer-provided address or other contact information. If the issuer 12 selected to send an electronic version of the check, then during operation 2024, an electronic version can be sent to the recipient 14. Sending the electronic version of the check to the recipient may be performed, for example, by sending an electronic check to a provided email address of the recipient. Alternatively, sending the electronic version of the check may include sending a message to the recipient indicating that the recipient may access and download an electronic version of the check from a secure website or message store associated with the server 150. Other methods of delivery are possible as well (e.g., sending a secure, unique link to enable access, or the like).

Operation 2026 includes receiving the check. For example, the recipient 14 receives either the paper version or the electronic version of the check.

In some examples, the delivery method selected in operation 2016 is the issuer 12 showing an electronic image of the check to the recipient 14 while they are proximate to each other in a same physical space. The recipient (e.g., via their device 120) receives the check in operation 2026 via them taking picture of the issuer device 100 displaying the electronic check and then processing the picture using a mobile deposit process. This can bypass the use of the server 150 to send the check in operation 2020. In an alternative process, the electronic version of the check is sent from the server 150 to the issuer device 100 for displaying on the screen of the device 100 so the recipient 14 can take a picture with their device 120.

Operation 2028 includes depositing the check. For example, the recipient 14 can deposit the check using the recipient device 120. Depositing a physical check may be performed, for example, using a check clearance or realtime payments process as described above. Depositing an electronic check may be performed similarly, for example by initiating an automated clearinghouse transaction or otherwise initiating presentment processes between a financial institution of the recipient 14 and that of the issuer 12. This may be initiated within an application on the recipient device 120 of the recipient 14 or may be initiated directly by server 150 by the recipient providing an appropriate account and routing number to which a deposit based on the check details should be initiated.

FIG. 21 illustrates an example set of server instructions 158 for execution of the electronic generation of a check. The server instructions 158 include operations 2102-2112 that may be performed by the server 150.

Operation 2102 includes receiving an indication of check creation. For example, the server 150 may receive check data from the issuer device 100.

Operation 2104 includes obtaining issuer-specific account information. For example, the server 150 may retrieve account information associated with the issuer 12.

Operation 2106 includes generating a two-dimensional code based on account information and enhanced information. The 2D code can be a random generated code linked to information in a data record, can be a URL leading to information, or can embed information. The server 150 can generate multiple types of 2D codes to be printed on the check. For example, the server 150 can generate both a QR code and a data matrix code.

In some embodiments, the QR code can encode link information that identifies a web server communicatively connected to the first server 150. This allows the check recipient to scan the QR code to access deposit options or payment conversion features. The QR code may encode a deep link to a mobile application associated with the bank or a URL to a web application.

The data matrix code can encode a unique identifier associated with the check issuer and the specific check. This identifier may be randomly generated and linked to information stored in a database record, rather than directly encoding sensitive account information. The server 150 can generate the unique identifier such that it does not reflect the actual account number of the check issuer, providing enhanced security.

The server 150 can encode multiple functions into a single 2D code by leveraging the capacity of codes (e.g., QR codes) to store lengthy alphanumeric strings. The encoded data can include, for example, basic information like customer identification, account number (in encrypted or aliased form), and check number, as well as enriched data including payee information, amount, date, and geolocation. This may include, for example a combination of public information accessible to recipients and private information only readable by bank systems. For enhanced security, the server 150 can encrypt sensitive data encoded in the 2D codes such that it can only be decrypted if the recipient has securely logged into an authorized banking application. The server 150 can also incorporate digital watermarking technology into the check generation process to provide an additional layer of security and fraud prevention.

The generated 2D codes are stored, e.g., by server 150, and connected to both the issuer account and the specific check, enabling later validation and processing. This creates a secure link between the physical check, the encoded data, and bank records without exposing sensitive account information.

Operation 2108 includes determining whether to generate a physical or digital check based on input received from the issuer device 100.

Operation 2110 includes transmitting a digital version to the recipient with negotiation instructions. For example, if the issuer 12 selected to send an electronic version of the check, the server 150 can send the electronic version with instructions for how the recipient 14 can negotiate or deposit the check.

Operation 2112 includes generating a physical check for mailing and transmitting an electronic receipt. For example, if the issuer 12 selected to mail a paper version of the check, the server 150 can initiate generation and mailing of the paper check and send a confirmation to the issuer device 100, as noted above.

FIG. 22 illustrates a user interface 2200 for electronic generation of a check that can be displayed by the issuer device 100. The user interface 2200 includes multiple regions organized to facilitate efficient check creation and validation.

In the example shown, the user interface 2200 includes input fields 2202 for entering check data, including a date field, a payee name field for entering the check recipient identity, an amount field that includes separate sections for numerical and written amounts, a memo field, and a signature capture area 2204 for the issuer's signature. Other fields may be displayed as well, for example to capture physical mailing instructions or digital delivery instructions for providing a generated check to an intended recipient.

The user interface 2200 implements input validation features to ensure data accuracy. For example, when the issuer inputs check data, the application performs optical character recognition to extract and validate the entered information. The user interface displays the extracted data and provides text fields allowing the issuer to modify any incorrectly captured information.

In the example shown, the user interface 2200 displays a real-time preview 2206 of the check that updates as the issuer enters data. The preview shows the input check data formatted as it will appear on the final check, the generated 2D codes that will be printed on the check, and visual indicators showing where the anchor points will be positioned on the check. The preview functionality allows the issuer to verify the check's appearance before creation. The preview includes both the front and back views of the check, showing the placement of the QR code and data matrix on each side.

In the example shown, the user interface 2200 provides delivery method options through selectable interface elements, including a “create physical check” button 2208, a “send digital check” button 2210, and a “create check” button 2212 to finalize check creation. An optional “preview” button to review check details (e.g., delivery details) may be included as well.

When the issuer selects a delivery method, the user interface 2200 displays additional relevant options. For physical checks, it shows mailing address input fields. For digital checks, it presents options for electronic delivery methods and allows the issuer to include instructions for the recipient on how to negotiate or deposit the check.

### Automated Check Detection, Initiation of Check Registration, Validation, or Audit

In some instances, a check holder (e.g., the issuer, recipient, or current possessor of a check) may wish to perform a transaction associated with the check. Such transactions may include creating a validation record (e.g., registration), creation of an audit trail as a middleman-possessor of the check, or a check recipient/payee intending to deposit or receive funds implicated by the check. However, users may otherwise be required to select a particular mobile application (e.g., of a financial institution) and initiate a particular transaction before a user interface is even presented allowing the user to capture an image of the check. In accordance with the present disclosure, a check may automatically be detected in a native mobile camera application, and particular features of the check (e.g., as described above in conjunction with FIGS. 2-3) may indicate the presence of a check, or indicate to execute particular instructions on the mobile device to initiate a check-related transaction such as those described above.

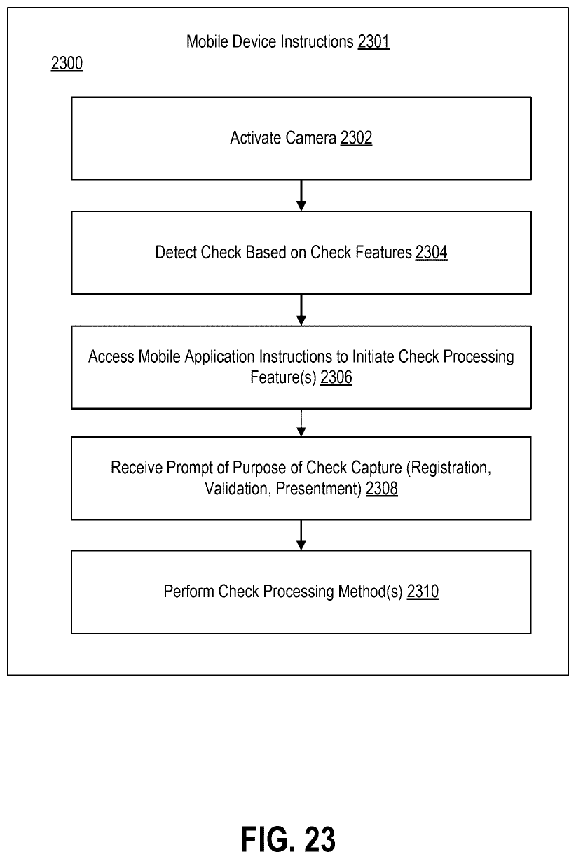

FIG. 23 illustrates an example method 2300 including mobile device instructions 2301 for automatic capture of check information. One or more of the issuer device 100 or the recipient device 120 may include the mobile device instructions 2301. The method 2300 can begin with operation 2302.

Operation 2302 includes activating a camera. For example, the recipient device 120 or issuer device 100 can activate a camera application to capture an image of a check.

Operation 2304 includes detecting a check based on check features. For example, the mobile device can use computer vision technology to automatically recognize that a check is present in the camera view. The device can identify the check using the anchor points 212a-c or 306a-c printed on the corners of the check. The anchor points assist with recognition and rapid alignment of the check. Additionally or alternatively, the camera may identify the object as a check based on, e.g., information included in a 2D code presented on the check that may indicate to the mobile device to perform one or more additional routines (e.g., as may be available at a link referenced in the 2D code).

Operation 2306 includes accessing mobile application instructions to initiate check processing features. For example, in response to detecting the check, the mobile device can generate a link that leads to a mobile check deposit process provided by a web application or a mobile application. The computer vision technology can automatically recognize the check and launch the appropriate application.

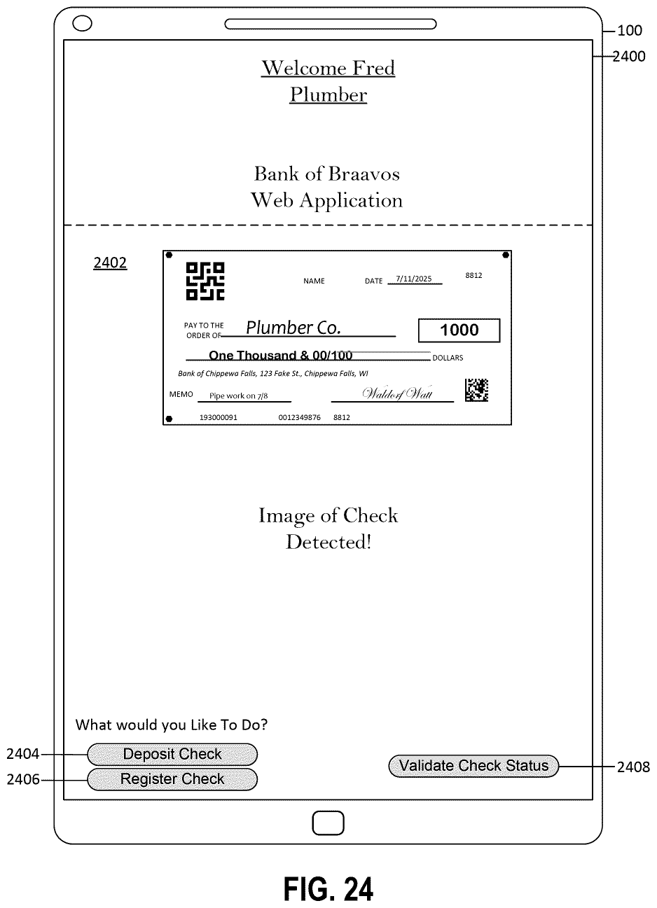

Operation 2308 includes receiving a prompt regarding the purpose of check capture. For example, the mobile device can display options for how to process the detected check, such as registration, validation, or deposit. Such a user interface may be as presented in FIG. 24.

Operation 2310 includes performing check processing methods. Based on the selected purpose, the mobile device can initiate the corresponding check processing workflow, such as check registration as described in FIG. 4, check validation as described in FIG. 8, check deposit as described in FIG. 7, or various other methods, such as initiating realtime payments as described in conjunction with FIGS. 17 and 18.

FIG. 24 illustrates a user interface 2400 for automatic capture of check information. The user interface can be displayed by the recipient device 120 after detecting a check in the camera view.

The user interface 2400 includes a camera viewfinder 2402 showing the detected check. The mobile device uses the anchor points printed on the check for recognition and rapid alignment. The device can identify the check boundaries and normalize the check position within the viewfinder.

The user interface 2400 displays options for processing the detected check, including a “Deposit Check” option 2404 to initiate mobile deposit, a “Register Check” option 2406 to create a validation object, and a “Validate Check Status” option 2408 to verify the check against an existing validation object.

The instructions as provided on a recipient device 120 can automatically detect and decode 2D codes printed on the check. For example, if the check includes a QR code, the mobile device can extract an encoded URL and use it to launch a corresponding web application or mobile application. The 2D codes may encode deep links that automatically open specific features within a banking application.

Generally speaking, the user interface and instructions on the mobile device leverage image processing technology to, e.g., recognize the check using the anchor points, extract data from the check using optical character recognition, connect decoded 2D code data with other extracted check information, or transmit the collective check data to backend banking systems.

### Computing Environment

FIG. 25 discloses a computing environment 2500 in which aspects of the present disclosure may be implemented. A computing environment 2500 is a set of one or more virtual or physical computers 2510 that individually or in cooperation achieve tasks, such as implementing one or more aspects described herein. The computers 2510 have components that cooperate to cause output based on input. Example computers 2510 include desktops, servers, mobile devices (e.g., smart phones and laptops), wearables, virtual reality devices, augmented reality devices, expanded reality devices, spatial computing devices, virtualized devices, other computers, or combinations thereof. In particular example implementations, the computing environment 2500 includes at least one physical computer.

The computing environment 2500 may specifically be used to implement one or more aspects described herein. In some examples, one or more of the computers 2510 may be implemented as a user device, such as mobile device and others of the computers 2510 may be used to implement aspects of a machine learning framework useable to train and deploy models exposed to the mobile device or provide other functionality, such as through exposed application programming interfaces.

The computing environment 2500 can be arranged in any of a variety of ways. The computers 2510 can be local to or remote from other computers 2510 of the environment 2500. The computing environment 2500 can include computers 2510 arranged according to client-server models, peer-to-peer models, edge computing models, other models, or combinations thereof.

In many examples, the computers 2510 are communicatively coupled with devices internal or external to the computing environment 2500 via a network 2502. The network 2502 is a set of devices that facilitate communication from a sender to a destination, such as by implementing communication protocols. Example networks 2502 include local area networks, wide area networks, intranets, or the Internet.

In some implementations, computers 2510 can be general-purpose computing devices (e.g., consumer computing devices). In some instances, via hardware or software configuration, computers 2510 can be special purpose computing devices, such as servers able to practically handle large amounts of client traffic, machine learning devices able to practically train machine learning models, data stores able to practically store and respond to requests for large amounts of data, other special purposes computers, or combinations thereof. The relative differences in capabilities of different kinds of computing devices can result in certain devices specializing in certain tasks. For instance, a machine learning model may be trained on a powerful computing device and then stored on a relatively lower powered device for use. Such relatively low powered device may nonetheless be specially configured for such inference tasks so that it performs inference faster or more efficiently than a standard desktop or laptop computer.

Many example computers 2510 include a processor set 2512, a memory set 2514, and an interface set 2518. Such components can be virtual, physical, or combinations thereof.

The processor set 2512 is a set of one or more processors. Processors are components that execute instructions, such as instructions that obtain data, process the data, and provide output based on the processing. The processor set 2512 often (collectively or individually) obtain instructions and data stored by the memory set 2514. The processors of the processor set 2512 can take any of a variety of forms, such as central processing units, graphics processing units, coprocessors, tensor processing units, artificial intelligence accelerators, microcontrollers, microprocessors, application-specific integrated circuits, field programmable gate arrays, other processors, or combinations thereof. In example implementations, the processor set 2512 includes at least one physical processor implemented as an electrical circuit. Example providers or designers of processors 2512 include INTEL, AMD, QUALCOMM, TEXAS INSTRUMENTS, and APPLE.

The memory set 2514 is a collection of components configured to store instructions 2516 and data for later retrieval and use. The instructions 2516 can, when executed by one or more processors of processor set 2512, cause execution of one or more operations that implement aspects described herein. In many examples, the memory 2514 is a non-transitory computer readable medium, such as random-access memory, read only memory, cache memory, registers, portable memory (e.g., enclosed drives or optical disks), mass storage devices, hard drives, solid state drives, other kinds of memory, or combinations thereof. In certain circumstances, the memory set 2514 can include transitory memory that stores information encoded in transient signals.

The interface set 2518 is a set of one or more components that facilitate receiving input from and providing output to something external to the computer 2510, such as visual output components (e.g., displays or lights), audio output components (e.g., speakers), haptic output components (e.g., vibratory components), visual input components (e.g., cameras), auditory input components (e.g., microphones), haptic input components (e.g., touch or vibration sensitive components), motion input components (e.g., mice, gesture controllers, finger trackers, eye trackers, or movement sensors), buttons (e.g., keyboards or mouse buttons), position sensors (e.g., terrestrial or satellite-based position sensors such as those using the Global Positioning System), other input components, or combinations thereof (e.g., a touch sensitive display). The interfaces set 2518 can include one or more components for sending or receiving data from other computing environments or electronic devices, such as one or more wired connections (e.g., Universal Serial Bus connections, THUNDERBOLT connections, ETHERNET connections, serial ports, or parallel ports) or wireless connections (e.g., via components configured to communicate via radiofrequency signals, such as according to WI-FI, cellular, BLUETOOTH, ZIGBEE, or other protocols). One or more of the one or more interfaces 2518 can facilitate connection of the computing environment 2500 to a network 2590.

The computers 2510 can include any of a variety of other components to facilitate performance of operations described herein. Example components include one or more power units (e.g., batteries, capacitors, power harvesters, or power supplies) that provide operational power, one or more busses to provide intra-device communication, one or more cases or housings to encase one or more components, other components, or combinations thereof.

A person of skill in the art, having benefit of this disclosure, may recognize various ways for implementing technology described herein, such as by using any of a variety of programming languages (e.g., a C-family programming language, PYTHON, JAVA, RUST, HASKELL, other languages, or combinations thereof), libraries or packages (e.g., that provide functions for obtaining, processing, and presenting data, such as may be obtained using a package manager like PIP or CONDA), compilers, and interpreters to implement aspects described herein. Example libraries include NLTK (Natural Language Toolkit) by Team NLTK (providing natural language functionality), PYTORCH by META (providing machine learning functionality), NUMPY by the NUMPY Developers (providing mathematical functions), and BOOST by the Boost Community (providing various data structures and functions) among others. Operating systems (e.g., WINDOWS, LINUX, MACOS, IOS, and ANDROID) may provide their own libraries or application programming interfaces useful for implementing aspects described herein, including user interfaces and interacting with hardware or software components. Web applications can also be used, such as those implemented using JAVASCRIPT or another language. A person of skill in the art, with the benefit of the disclosure herein, can use programming tools to assist in the creation of software or hardware to achieve techniques described herein, such as intelligent code completion tools (e.g., INTELLISENSE) and artificial intelligence tools (e.g., GITHUB COPILOT by MICROSOFT or CODE LLAMA by META).

In some examples, large language models can be used to understand natural language, generate natural language, or perform other tasks. Examples of such large language models include CHATGPT or other flagship models (GPT-4o, o1, o3, or others as released) by OPENAI, a LLAMA model by META, a CLAUDE model by ANTHROPIC, a GEMINI model by GOOGLE, others, or combinations thereof. Such models can be fine-tuned on relevant data using any of a variety of techniques to improve the accuracy and usefulness of the answers. The models can be run locally on server or client devices or accessed via an application programming interface. Some of those models or services provided by entities responsible for the models may include other features, such as speech-to-text features, text-to-speech, image analysis, research features, and other features, which may also be used as applicable.

### Machine Learning Framework

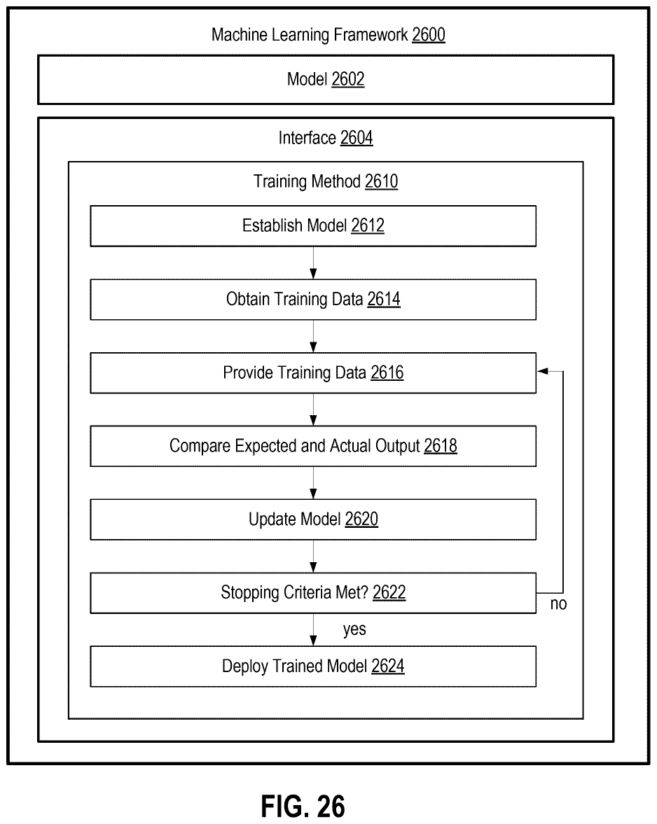

FIG. 26 illustrates an example machine learning framework 2600 that techniques described herein may benefit from or improve on. A machine learning framework 2600 is a collection of software and data that implements artificial intelligence trained to provide output, such as predictive data, based on input. Examples of artificial intelligence that can be implemented with machine learning way include neural networks (including recurrent neural networks), language models (including so-called “large language models”), generative models, natural language processing models, adversarial networks, decision trees, Markov models, support vector machines, genetic algorithms, others, or combinations thereof. A person of skill in the art having the benefit of this disclosure will understand that these artificial intelligence implementations need not be equivalent to each other and may instead select from among them based on the context in which they will be used. Machine learning frameworks 2600 or components thereof are often built or refined from existing frameworks, such as TENSORFLOW by GOOGLE, INC. or PYTORCH by the PYTORCH community.

The machine learning framework 2600 can include one or more models 2602 that are the structured representation of learning and an interface 2604 that supports use of the model 2602.

The model 2602 can take any of a variety of forms. In many examples, the model 2602 includes representations of nodes (e.g., neural network nodes, decision tree nodes, Markov model nodes, other nodes, or combinations thereof) and connections between nodes (e.g., weighted or unweighted unidirectional or bidirectional connections). In certain implementations, the model 2602 can include a representation of memory (e.g., providing long short-term memory functionality). Where the set includes more than one model 2602, the models 2602 can be linked, cooperate, or compete to provide output.

The interface 2604 can include software procedures (e.g., defined in a library) that facilitate the use of the model 2602, such as by providing a way to establish and interact with the model 2602. For instance, the software procedures can include software for receiving input, preparing input for use (e.g., by performing vector embedding, such as using Word2Vec, BERT, or another technique), processing the input with the model 2602, providing output, training the model 2602, performing inference with the model 2602, fine tuning the model 2602, other procedures, or combinations thereof.

In an example implementation, interface 2604 can be used to facilitate a training method 2610 that can include operation 2612. Operation 2612 includes establishing a model 2602, such as initializing a model 2602. The establishing can include setting up the model 2602 for further use (e.g., by training or fine tuning). The model 2602 can be initialized with values. In examples, the model 2602 can be pretrained. Operation 2614 can follow operation 2612. Operation 2614 includes obtaining training data. In many examples, the training data includes pairs of input and desired output given the input. In supervised or semi-supervised training, the data can be prelabeled, such as by human or automated labelers. In unsupervised learning the training data can be unlabeled. The training data can include validation data used to validate the trained model 2602. Operation 2616 can follow operation 2614. Operation 2616 includes providing a portion of the training data to the model 2602. This can include providing the training data in a format usable by the model 2602. The framework 2600 (e.g., via the interface 2604) can cause the model 2602 to produce an output based on the input. Operation 2618 can follow operation 2616. Operation 2618 includes comparing the expected output with the actual output. In an example, this can include applying a loss function to determine the difference between expected and actual. This value can be used to determine how training is progressing. Operation 2620 can follow operation 2618. Operation 2620 includes updating the model 2602 based on the result of the comparison. This can take any of a variety of forms depending on the nature of the model 2602. Where the model 2602 includes weights, the weights can be modified to increase the likelihood that the model 2602 will produce correct output given an input. Depending on the model 2602, backpropagation or other techniques can be used to update the model 2602. Operation 2622 can follow operation 2620. Operation 2622 includes determining whether a stopping criterion has been reached, such as based on the output of the loss function (e.g., actual value or change in value over time). In addition or instead, whether the stopping criterion has been reached can be determined based on a number of training epochs that have occurred or an amount of training data that has been used. In some examples, satisfaction of the stopping criterion can include If the stopping criterion has not been satisfied, the flow of the method can return to operation 2614. If the stopping criterion has been satisfied, the flow can move to operation 2622. Operation 2622 includes deploying the trained model 2602 for use in production, such as providing the trained model 2602 with real-world input data and produce output data used in a real-world process. The model 2602 can be stored in memory 2514 of at least one computer 2510, or distributed across memories of two or more such computers 2510 for production of output data (e.g., predictive data).

### Application of Techniques

Techniques herein may be applicable to improving technological processes of a financial institution, such as technological aspects of transactions (e.g., resisting fraud, entering loan agreements, transferring financial instruments, or facilitating payments). Although technology may be related to processes performed by a financial institution, unless otherwise explicitly stated, claimed inventions are not directed to fundamental economic principles, fundamental economic practices, commercial interactions, legal interactions, or other patent ineligible subject matter without something significantly more.

Where implementations involve personal or corporate data, that data can be stored in a manner consistent with relevant laws and with a defined privacy policy. In certain circumstances, the data can be decentralized, anonymized, or fuzzed to reduce the amount of accurate private data that is stored or accessible at a particular computer. The data can be stored in accordance with a classification system that reflects the level of sensitivity of the data and that encourages human or computer handlers to treat the data with a commensurate level of care.

Where implementations involve machine learning, machine learning can be used according to a defined machine learning policy. The policy can encourage training of a machine learning model with a diverse set of training data. Further, the policy can encourage testing for and correcting undesirable bias embodied in the machine learning model. The machine learning model can further be aligned such that the machine learning model tends to produce output consistent with a predetermined morality. Where machine learning models are used in relation to a process that makes decisions affecting individuals, the machine learning model can be configured to be explainable such that the reasons behind the decision can be known or determinable. The machine learning model can be trained or configured to avoid making decisions based on protected characteristics.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A system comprising:
a first mobile device associated with a first user;
a second mobile device associated with a second user;
a first server associated with a first user account;
a second server associated with a second user account;
wherein the first server is configured to:
receive, from the first mobile device, a first document image of a document associated with a first visual appearance, a first value, the first user account, and a first document recipient identity, wherein the first document image includes colors other than bitonal black and white, wherein the document comprises a first two-dimensional code printed on a front side of the document that encodes an identifier associated with the document, and wherein the document comprises a second two-dimensional code printed on a back side of the document that encodes the identifier associated with the document;
responsive to receiving the first document image, modify a record associated with the first user account based on the first value;
wherein the first mobile device is configured to:
receive a first inquiry from the first user regarding the first user account;
responsive to receiving the first inquiry, provide a user interface showing:
first data for the first user account based on the modified record, wherein the first data is provided in a first user interface style;
a first user interface element;
detect actuation of the first user interface element; and
responsive to detecting the actuation of the first user interface element, provide the first document image;
wherein the first server is configured to:
from the second server, receive document data originating from the second mobile device, wherein the document data is associated with a second value, a second document recipient identity, and a second document image of the document having a second visual appearance, wherein the second document image of the document is a bitonal black-and-white image, wherein one or more of the second value or the second document recipient identity is fraudulently altered;
apply a fraud detection process comprising:
determining that the first visual appearance and the second visual appearance are not in accordance, wherein determining that the first visual appearance and the second visual are not in accordance comprises:
determining, using a pre-trained machine learning model fine-tuned to determine object similarity across color images and black-and-white images, a similarity score for the first document image and the second document image, wherein fine-tuning the pre-trained machine learning model comprises using a plurality of training instances, wherein each training instance of the plurality of training instances comprises (i) a high-resolution color image of a first document, (ii) a black-and-white image of a second document formatted in a tag image file format (TIFF), and (iii) a label, wherein the label is positive when the first document and the second document are a same document, and the label is negative when the first document and the second document are different documents, wherein fine-tuning the pre-trained machine learning model comprises using contrastive learning to update model weights, such that, when the label is positive, embeddings generated for the black-and-white image and for the high-resolution color image are learned to be near one another in a latent space, and when the label is negative, the embeddings generated for the black-and-white image and for the high-resolution color image are learned to be far from one another in the latent space;
based on the similarity score and a threshold value, determining that the first visual appearance and the second visual appearance are not in accordance;
decode a third two-dimensional code printed on a front side of the document in the second document image to determine a second identifier
decode a fourth two-dimensional code printed on a back side of the document in the second document image to determine a third identifier;
determine that the second identifier and the third identifier do not match;
based on determining that the first visual appearance and the second visual appearance are not in accordance and based on determining that the second identifier and the third identifier do not match, determine that the document data fails the fraud detection process;
responsive to the document data failing the fraud detection process:
send an alert to the first mobile device that the document data failed the fraud detection process;
wherein the first mobile device is configured to:
receive the alert from the first server;
receive a second inquiry from the first user regarding the first user account;
responsive to receiving the second inquiry, provide the user interface showing a second data for the first user account that accounts for the document failing the fraud detection process, wherein the second data is provided in a second user interface style different from the first user interface style; and
responsive to receiving a selection of a button or a thumbnail in the user interface, display a popup window that simultaneously displays the first document image and the second document image.

2. The system of claim 1,
wherein the first mobile device is configured to:
display the second value and the second document recipient identity;
receive, from the first user, a denial of the document data; and
send the denial of the document data to the first server.

3. (canceled)

4. The system of claim 1, wherein an account number of the check issuer account is not printed on the check.

5. The system of claim 1,
wherein an additional two-dimensional (2D) code is printed on the document;
wherein the additional 2D code encodes a deep link to a mobile application associated with a first bank;
wherein the first mobile device is configured to:
scan the additional 2D code;
responsive to scanning the additional 2D code, launch the mobile application;
display, by the mobile application, an option to deposit a check and an option to register a check;
receive, from the first user, a selection of the option to register a check;
using the mobile application and a camera of the first mobile device, capture the first document image.

6. The system of claim 1,
wherein the first server is configured to, based on the identifier associated with the document, determine the first user account from a plurality of accounts, wherein the first two-dimensional code is decoded to determine the identifier.

7. The system of claim 1,
wherein the first mobile device is configured to:
capture the first document image of the document;
identify, in the first document image of the document, the first two-dimensional code;
decode the first two-dimensional code to determine the identifier;
apply optical character recognition to determine an amount on the document and to determine a document recipient identity on the0 document;
display a registration confirmation user interface showing:
the amount on the document determined by optical character recognition and a first text field to modify the amount on the document; and
the document recipient identity determined by optical character recognition and a second text field to modify the document recipient identity;
receive, from the first user, a modification of one or more of the amount on the document or the document recipient identity; and
send, to the first server, the first document image, the amount, and the document recipient identity.

8. The system of claim 7,
wherein the second two-dimensional code is concealed with a removable material.

9. The system of claim 1,
wherein an account number of the check issuer account is not printed on the check.

10. The system of claim 1,
wherein three anchor points are printed on the front of the check, wherein each anchor point of the three anchor points is printed in a respective corner of the front of the document; and
wherein the first mobile device is configured to capture the first document image, wherein capturing the first document image comprises identifying each of the three anchor points in an image captured by a camera of the first mobile device and aligning the document in the image based on the three anchor points.

11. The system of claim 1,
wherein the first server includes a database storing a plurality of validation objects, wherein each validation object of the plurality of validation objects comprises a respective account, a respective amount, a respective document recipient identity, and a respective document image;
wherein the first server is configured to:
receive, from the second server, the second document image; and
using the identifier associated with the document, identify, from the plurality of validation objects, a validation object corresponding to the document.

12. The system of claim 1,
wherein the first user is a customer of a first bank;
wherein the second user is a customer of a second bank; and
wherein the first bank is different from the second bank.

13. The system of claim 1,
wherein the user interface shows completed transactions, pending transactions, and voided transactions;
wherein the user interface includes a pending checks region displaying at least one pending check record, the at least one pending check record including at least one image of a check that has not yet been voided or deposited.

14. The system of claim 13, wherein the user interface includes a settled checks region displaying at least one settled check record, the at least one settled check record including a first check image captured prior to check presentment and a second check image obtained from a deposit institution.

15. The system of claim 13, wherein the user interface includes a void checks region displaying at least one void check record, the at least one void check record including one or more images of a voided check.

16. A method comprising:
at a server:
receiving, from a first mobile device, a first check image of a check associated with a first visual appearance, a first amount, a check issuer account, and a first check recipient identity, wherein the first check image includes colors other than pure black and pure white, wherein the check comprises a first two-dimensional code printed on a front side of the check that encodes an identifier associated with the check, and wherein the check comprises a second two-dimensional code printed on a back side of the check that encodes the identifier associated with the check; and
responsive to receiving the first check image of the check, modifying a record associated with the check issuer account based on the first amount;
at a mobile device:
receiving a first account balance inquiry from a user regarding the check issuer account;
responsive to receiving the first account balance inquiry, providing an account balance user interface showing:
a balance for the check issuer account based on the modified record, wherein the balance is provided in a first user interface style;
a first user interface element;
detecting actuation of the first user interface element; and
responsive to detecting the actuation of the first user interface element, providing the first check image;
at the server:
receiving check deposit data originating from a second mobile device, wherein the check deposit data is associated with a second amount, a second check recipient identity, and a second check image of the check having a second visual appearance, wherein the second check image of the check is a bitonal black-and-white image;
applying a fraud detection process comprising:
(a) determining that the first amount and the second amount are in accordance;
(b) determining that the first check recipient identity and the second check recipient identity are in accordance; and
(c) determining that the first visual appearance and the second visual appearance are in accordance notwithstanding color differences in the images, wherein determining that the first visual appearance and the second visual are in accordance comprises:
determining, using a pre-trained machine learning model fine-tuned to determine object similarity across color images and black-and-white images, a similarity score for the first document image and the second document image, wherein fine-tuning the pre-trained machine learning model comprises using a plurality of training instances, wherein each training instance of the plurality of training instances comprises (i) a high-resolution color image of a first document, (ii) a black-and-white image of a second document formatted in a tag image file format (TIFF), and (iii) a label, wherein the label is positive when the first document and the second document are a same document, and the label is negative when the first document and the second document are different documents, wherein fine-tuning the pre-trained machine learning model comprises using contrastive learning to update model weights, such that, when the label is positive, embeddings generated for the black-and-white image and for the high-resolution color image are learned to be near one another in a latent space, and when the label is negative, the embeddings generated for the black-and-white image and for the high-resolution color image are learned to be far from one another in the latent space;
based on the similarity score and a threshold value, determining that the first visual appearance and the second visual appearance are in accordance; and
based on steps (a)-(c), determining that the check deposit data satisfies the fraud detection process; and
in response to the check deposit data satisfying the fraud detection process, approving a settlement of the check;
at the mobile device:
after approval of the settlement of the check, receiving a second account balance inquiry from the user regarding the check issuer account; and
responsive to receiving the second account balance inquiry, providing the account balance user interface showing a second balance for the check issuer account that accounts for the settlement of the check and is provided in a second user interface style different from the first user interface style.

17. The method of claim 16,
wherein the first mobile device is configured to:
display the second amount and the second check recipient identity;
receive, from the user, an approval of the second amount and the second check recipient identity; and
send the approval to the server;
wherein the server is configured to approve the settle of the check after receiving the approval of the second amount and the second check recipient identity from the mobile device.

18. (canceled)

19. (canceled)

20. A set of one or more non-transitory computer readable media having instructions that, when executed by a set of one or more processors, cause the processor set to:
receive, from a first mobile device, a first check image of a check associated with a first visual appearance, a first amount, a check issuer account, and a first check recipient identity, wherein the first check image includes colors other than bitonal black and white;
responsive to receiving the first check image, modify a record associated with the check issuer account based on the first amount;
provide, to the first mobile device, a first balance of the check issuer account to be displayed in a first user interface style;
from a second server, receive check deposit data originating from a second mobile device, wherein the check deposit data is associated with a second amount, a second check recipient identity, and a second check image of the check having a second visual appearance, wherein the second check image of the check is a bitonal black-and-white image, wherein one or more of the second amount or the second check recipient identity is fraudulently altered;
apply a fraud detection process comprising:
determining that the first visual appearance and the second visual appearance are not in accordance, wherein determining that the first visual appearance and the second visual are not in accordance comprises:
determining, using a pre-trained machine learning model fine-tuned to determine object similarity across color images and black-and-white images, a similarity score for the first document image and the second document image, wherein fine-tuning the pre-trained machine learning model comprises using a plurality of training instances, wherein each training instance of the plurality of training instances comprises (i) a high-resolution color image of a first document, (ii) a black-and-white image of a second document formatted in a tag image file format (TIFF), and (iii) a label, wherein the label is positive when the first document and the second document are a same document, and the label is negative when the second document is fraudulently modified, wherein fine-tuning the pre-trained machine learning model comprises using contrastive learning to update model weights, such that, when the label is positive, embeddings generated for the black-and-white image and for the high-resolution color image are learned to be near one another in a latent space, and when the label is negative, the embeddings generated for the black-and-white image and for the high-resolution color image are learned to be far from one another in the latent space;
based on the similarity score, determining that the first visual appearance and the second visual appearance are not in accordance; and
based on determining that the first visual appearance and the second visual appearance are not in accordance, determine that the check deposit data fails the fraud detection process;
responsive to the check deposit data failing the fraud detection process:
deny a settlement of the check;
void the check; and
send an alert to the first mobile device that the check deposit data failed the fraud detection process.
